(19) United States
(12) Patent Application Publication
(10) Pub. No.: US 2019/0354914 A1
(43) Pub. Date: Nov. 21, 2019

(54) Coordinating Execution of Predictive Models between Multiple Data Analytics Platforms to Predict Problems at an Asset

(71) Applicant: Uptake Technologies, Inc., Chicago, IL (US)

(72) Inventor: Brad Nicholas, Wheaton, IL (US)

(21) Appl. No.: 15/985,657

(22) Filed: May 21, 2018

(51) Int. Cl. G06Q 10/06; G06N 7/00; G06N 99/00; G06K 9/62

(52) U.S. Cl. CPC G06Q 10/06395; G06Q 10/0637; G06K 9/6269; G06N 99/005; G06N 7/00

(57) ABSTRACT

To distribute execution of a predictive model between multiple data analytics platforms, a first platform may be provisioned with a set of precursor detection models and a second platform may be provisioned with a set of precursor analysis models. Based on a given precursor detection model, the first platform may detect an occurrence of a given type of precursor event at a given asset and send data associated with the occurrence to the second platform. In response, the second platform may (a) identify at least one precursor analysis model that is associated with the given type of precursor event and predicts whether a given type of problem is present at an asset and (b) execute the at least one precursor analysis model to perform a deeper analysis of the occurrence and thereby output a prediction of whether the given type of problem is present at the given asset.

### BACKGROUND

Today, machines (also referred to herein as “assets”) are ubiquitous in many industries. From locomotives that transfer cargo across countries to farming equipment that harvest crops, assets play an important role in everyday life. Depending on the role that an asset serves, its complexity, and cost, may vary. For instance, some assets include multiple subsystems that must operate in harmony for the asset to function properly (e.g., an engine, transmission, etc.).

Because of the increasing role that assets play, it is also becoming increasingly desirable to monitor and analyze assets in operation. To facilitate this, some have developed mechanisms to monitor asset attributes and detect abnormal conditions at an asset. For instance, one approach for monitoring assets generally involves various sensors and/or actuators distributed throughout an asset that monitor the operating conditions of the asset and provide signals reflecting the asset's operation to an on-asset computer. As one representative example, if the asset is a locomotive, the sensors and/or actuators may monitor parameters such as temperatures, pressures, fluid levels, voltages, and/or speeds, among other examples. If the signals output by one or more of the sensors and/or actuators reach certain values, the on-asset computer may then generate an abnormal condition indicator, such as a “fault code,” which is an indication that an abnormal condition has occurred within the asset. The on-asset computer may also be configured to monitor for, detect, and generate data indicating other events that may occur at the asset, such as asset shutdowns, restarts, etc.

The on-asset computer may also be configured to send data reflecting the attributes of the asset, including operating data such as signal data, abnormal-condition indicators, and/or asset event indicators, to a remote location for further analysis. For instance, an organization that is interested in monitoring and analyzing assets in operation may deploy an asset data platform that is configured to receive and analyze this asset attributes data (among other asset-related data).

### Overview

While conventional on-asset computers are generally effective at triggering abnormal-condition indicators, such systems are typically reactionary. That is, by the time a conventional on-asset computer system triggers an indicator, a failure within the asset may have already occurred (or is about to occur), which may lead to costly downtime, among other disadvantages. Additionally, due to the limited resources and control-systems focus of conventional on-asset computers, these on-asset computers are generally not capable of running data analytics programs, such as predictive models, that analyze the operating data generated at the asset and make predictions regarding the operation of the asset. As such, the analysis of the operating data generated at the asset generally needs to be performed by a more advanced computer system that is capable of running predictive models and/or other data analytics programs. This type of computer system may be referred to as a “data analytics platform.”

In practice, an organization that is interested in monitoring and analyzing the operation of assets may deploy a central data analytics platform that is remote from the assets, such as a data analytics platform implemented in an Internet-accessible, public, private or hybrid cloud. This type of remote data analytics platform may also be referred to as an “asset data platform.” In such an arrangement, predictive models related to the operation of the asset may be trained and executed within the remote data analytics platform, which generally requires operating data for the assets to be transmitted to the remote data analytics platform over a network. This transmission may increase cost and/or introduce undesirable delay associated with the network transmissions between the asset and the asset data platform, and may also be infeasible when the asset moves outside of coverage of a communication network and/or when the corresponding value enabled by the predictive insights provided through the remote data analytics platform is insufficient to justify remote data collection, preparation, transmission, storage and management. Moreover, for certain types of predictive models, the need to execute the predictive model at a remote data analytics platform rather than locally at the asset may lead to limited, outdated and/or inaccurate predictions, which could eventually result in insufficient value or even undetected or incorrectly predicted problems at the asset.

To help address one or more of these issues, an asset may also be equipped with its own local data analytics platform (e.g., a local analytics device), which may enable an asset to run data analytics programs and perform other complex operations that are typically not possible with a conventional on-asset computer. For instance, a local data analytics platform may enable on-asset training and/or execution of predictive models that relate to the operation of the asset (as opposed to a training and/or execution by a remote data analytics platform). Equipping an asset with a local data analytics platform may thus help to overcome some of the downsides of training and/or executing a predictive model at a remote data analytics platform. For example, training and/or executing a predictive model locally at an asset, rather than at a remote data analytics platform, may reduce or eliminate the need for an asset to transmit certain asset-related data to the remote data analytics platform in connection with that predictive model. As a result, the local data analytics platform may reduce the cost and/or delay of training and/or executing the predictive model, and may also improve the reliability and/or accuracy of certain predictive models, among other advantages.

Further details regarding the use of a local analytics device at an asset to execute predictive models and perform other complex operations are provided in U.S. application Ser. Nos. 14/744,352, 14/744,362, 14/744,369, 14/963,207, 15/185,524, 15/599,360, and 15/696,137, which are all owned by Uptake Technologies, Inc. and are all incorporated herein by reference.

While an asset equipped with a local data analytics platform may be capable of training and/or executing a predictive model, there may still be advantages to having the remote data analytics platform involved in the process of training and/or executing a predictive model. One such advantage is that the remote data analytics platform is generally capable of training and/or executing predictive models that render more accurate predictions than predictive models that are trained and/or executed by an asset's local data analytics platform.

For instance, the remote data analytics platform generally possesses greater computational power (e.g., processing capability, memory, storage, etc.) than the local analytics device, which may enable the remote computing system to train and/or execute predictive models that are more complex—and typically more accurate—than the predictive models that can be trained and/or executed by the asset's local analytics device. Additionally, the remote data analytics platform generally has access to other data related to the operation of the asset that is not available to a local data analytics platform, such as repair history data, weather data, operating data for other assets, etc., which may also enable the remote data analytics platform to train and/or execute predictive models that are more accurate than the predictive models that can be trained and/or executed by the asset's local data analytics platform.

The higher level of prediction accuracy achieved by a remote data analytics platform may lead to a reduction in the costs associated with maintaining assets because there may be less false negatives (e.g., missed failures that lead to costly downtime) and/or fewer false positives (e.g., inaccurate predictions of failures that lead to unnecessary maintenance). Thus, it would be desirable to leverage the benefits of both a data analytics platform located close to the source of the data on which a predictive model is based (e.g., a local data analytics platform on an asset) and a data analytics platform that possesses greater computational power and/or has access to a wider range of data that is relevant to the training and/or execution of predictive models (e.g., a remote data analytics platform implemented in an Internet connected public, private or hybrid cloud).

In view of the foregoing, disclosed herein are example systems, devices, and methods for distributing the execution of a predictive model between multiple data analytics platforms. At times below, the disclosed systems, devices, and methods may be described in the context of distributing the execution of a predictive model between a local analytics device at an asset and an asset data platform that is remote from the asset. However, it should be understood that this arrangement is merely described for purposes of illustration, and that the present disclosure is not limited to distributing the execution of a predictive model between an asset's local analytics device and an asset data platform. To the contrary, the disclosed systems, devices, and methods may be used in any context where it would be advantageous to distribute execution of a predictive model between multiple data analytics platforms. This includes distributed execution of a predictive model between an asset's local analytics device and a data analytics platform at the same general location as the asset (e.g., at a job site or wind farm), distributed execution of a predictive model between a data analytics platform at an asset's location and a data analytics platform that is remote from the asset (e.g., a cloud-based data analytics platform), and distributed execution of a predictive model between two local analytics devices.

In addition, the disclosed systems, devices, and methods may also be used to distribute execution of a predictive model between more than two data analytics platforms, such as distributed execution of a predictive model between three or more data analytics platforms that form a “daisy-chained” arrangement. For example, the disclosed systems, devices, and methods may also be used to distribute execution of a predictive model between a local analytics device on an asset, a data analytics platform at a job site, wind farm, or the like, and a cloud-based data analytics platform. The disclosed systems, devices, and methods may be used to in various other arrangements as well.

In accordance with the present disclosure, a first data analytics platform (e.g., a local analytics device or a data analytics platform at a job site) may be provisioned with a first set of one or more predictive models related to the operation of a given asset, referred to herein as “precursor detection models.” Each respective precursor detection model may be a predictive model that is used by the first data analytics platform to detect occurrences of a respective type of “precursor event” at the given asset, which is a change in the operating condition of an asset that is indicative of a potential problem at the asset and thus merits deeper analysis. For example, a given precursor detection model may be used to detect occurrences of a given type of precursor event that is indicative of a potential failure at the given asset (e.g., a failure of a given component or subsystem of given asset). As another example, a given precursor detection model may be used to detect occurrences of a given type of precursor event that is indicative of the presence of a potential signal anomaly at the given asset. A precursor detection model may be configured to detect occurrences of a precursor event that is indicative of another type of potential problem or condition of interest at the given asset as well.

The one or more precursor detection models may take various forms. According to one implementation, a precursor detection model may be configured to (1) receive, as input data, operating data for an asset, (2) perform certain data analytics on the input data to determine whether there has been an occurrence of the model's respective type of precursor event (i.e., whether there has been a particular type of change in the asset's operating condition that is indicative of a potential problem at the asset), and (3) output data associated with each detected occurrence of the model's respective type of precursor event. In this implementation, the data associated with each occurrence of the given type of precursor event may take various forms.

As one possibility, the data associated with each occurrence of the given type of precursor event may comprise an indicator that the precursor detection model outputs each time an occurrence of the given type of precursor event is detected, which may be referred to as a “precursor event indicator.” Such a precursor event indicator may take various forms. As one example, the precursor event indicator may comprise a descriptor of the respective type of precursor event detected by the model (e.g., a code or other alphanumerical descriptor). As another example, the precursor event indicator may simply take the form of a binary bit, a flag, or the like, in which case the asset may associate the indicator with a descriptor of the respective type of precursor event detected by the model when reporting a precursor event occurrence to other systems (e.g., the remote data platform). In either example, a precursor event indicator may also include or be associated with an indication of a time at which a precursor event occurrence has been detected, a location at which a precursor event occurrence has been detected, and/or a confidence value associated with a detection of a precursor event occurrence. A precursor event indicator output by a precursor detection model may take other forms as well.

As another possibility, in addition (or in alternative) to outputting a precursor event indicator each time a precursor event occurrence is detected, the precursor detection model may output (or the given asset may otherwise generate) a representation of operating data that is related to a precursor event occurrence. For example, the precursor detection model may output a snapshot of the raw operating data that led to the precursor detection model detecting a precursor event occurrence (e.g., operating data input into the model at or around the time that the precursor event occurrence was detected). As another example, the precursor detection model may output data derived from the raw operating data that led to the precursor detection model detecting a precursor event occurrence at the asset 106, such as a “roll-up” of the raw operating data (e.g., an average, mean, median, etc. of the values for an operating data variable over a given time window) or one or more features determined based on the raw operating data. The precursor detection model may output (or the given asset may otherwise generate) other representations of operating data related to a precursor event occurrence as well.

In accordance with the present disclosure, a second data analytics system (e.g., an asset data platform locate remotely from a job site) may then be provisioned with a second set of one or more predictive models related to the operation of the given asset, referred to herein as “precursor analysis models.” Each respective precursor analysis model may be a predictive model that is used by the second data analytics system to perform a deeper analysis of occurrences of a respective type of precursor event detected at an asset and thereby predict whether a respective type of problem is present at the asset. For example, a given precursor analysis model may be used to analyze a precursor event occurrence of a respective type detected at an asset and thereby predict whether a failure is likely to occur at the asset in the near future (e.g., a failure of a given component or subsystem of given asset) in view of that precursor event occurrence. As another example, a given precursor analysis model may be used to analyze a precursor event occurrence at an asset and thereby predict whether there is a signal anomaly at the asset in view of that precursor event occurrence. A precursor analysis model may be configured to predict whether other types of problems are present at an asset as well.

The one or more precursor analysis models may take various forms. According to one implementation, a precursor analysis model may be configured to (1) receive, as input data, the data associated with a precursor event occurrence of a respective type as well as other “contextual” data available to the remote computing system that may be used to analyze the precursor event occurrence, (2) perform certain data analytics on the input values to predict whether a respective type of problem is present at the asset, and (3) output data indicating the model's prediction as to whether the respective type of problem is present at the asset.

In this implementation, the contextual data that is input into the precursor analysis model may take various forms. As one example, the contextual data may include one or more classes of data relevant to the respective type of problem that may generally not be available to an asset, such as repair history data, weather data, and/or operating data for other assets. As another example, the contextual data may include one or more classes of data that are generally available to an asset but are nevertheless not analyzed by the asset when monitoring for precursor event occurrences of the respective type. The contextual data may take other forms as well.

Likewise, in this implementation, the precursor analysis model's output may take various forms. As one example, the precursor analysis model may simply output a binary bit, a flag, or the like that indicates whether or not the model is predicting that the respective type of problem is present at an asset. As another example, the precursor analysis model may output a descriptor of the respective type of problem (e.g., a code or other alphanumerical descriptor) when it appears likely that such a problem is present at the asset and may otherwise not output any data (i.e., it may output a null). As yet another example, the precursor analysis model may output data indicating a likelihood that the respective type of problem is present at asset (e.g., a probability value ranging from 0 to 100). The precursor analysis model's output may take other forms as well.

An example embodiment of the interaction between a first data analytics platform provisioned with the set of one or more precursor detection models and a second data analytics platform provisioned with the set of one or more precursor analysis models will now be described. According to this example embodiment, the first data analytics platform may be executing the set of one or more precursor detection models, each of which is configured to detect occurrences of a respective type of precursor event at a given asset. While executing the set of one or more precursor detection models, the first data analytics platform may occasionally detect occurrences of one or more types of precursor events at the given asset that should be reported to the second data analytics platform for deeper analysis before a substantially viable predictive outcome can be inferred. In turn, the first data analytics platform may report the detected precursor event occurrences (perhaps along with supporting data) to the second data analytics platform. This reporting function may take various forms.

In one example, each time a new occurrence of a given type of precursor event is detected, the first data analytics platform may be configured to responsively send data and/or analysis associated with the new occurrence of the given type of precursor event to the second data analytics platform (and conversely, may be configured to not send this data in the absence of this detected precursor event). In another example, the first data analytics platform may be configured to compile data associated with precursor event occurrences that have been detected and then periodically send this data to the second data analytics platform (e.g., after a threshold number of precursor event occurrences have been detected). In yet another example, the first data analytics program may alter its activity to enable specialized analytics processing that is known beforehand to be analytically useful in the presence of a detected precursor condition. In still another example, the absence of a detected precursor condition may trigger a periodic status update event to be sent.

In any of these examples, in line with the discussion above, the data sent to the second data analytics platform may take various forms, examples of which may include a precursor event indicator (which may include or be associated with a type, time, location, etc. of the precursor event occurrence) and perhaps also a representation of operating data that is related to the precursor event occurrence(s), such as the raw operating data that led to the detection of the precursor event occurrence and/or data derived therefrom (e.g., roll up data or some other computational output of the local analytics device). The function of reporting precursor event occurrences to the second data analytics platform may take other forms as well.

As a result of these functions being performed by the first data analytics platform, the second data analytics platform may receive data associated with occurrences of one or more types of precursor events, including at least a first precursor event occurrence of a first type. In response to receiving data associated with the first precursor event occurrence of the first type, the second data analytics platform may (1) identify at least a first precursor analysis model that is configured to perform a deeper analysis of precursor event occurrences of the first type and thereby predict whether a first type of problem is present at the given asset and (2) execute the first precursor analysis model in order to perform a deeper analysis of the first precursor event occurrence and thereby predict whether the first type of problem is present at the given asset. (It should be understood that the second data analytics platform could be provisioned with multiple precursor analysis models that are used to perform a deeper analysis of occurrences of the first type of precursor event, in which case the second data analytics platform may identify and execute multiple different precursor analysis models in response to receiving the first precursor event occurrence).

After performing the deeper analysis of the first precursor event occurrence, the second data analytics platform may then take one or more actions. As one example, the action may be to send an indication of the results of the second data analytics platform's deeper analysis back to the first data analytics platform (and/or to the given asset, if the first data analytics platform is located elsewhere), such as data indicating the first precursor analysis model's prediction as to whether the first type of problem is present at the given asset, perhaps along with one or more commands that facilitate modifying the configuration and/or operation of the given asset or the local data analytics platform itself. In practice, the second data analytics platform may be configured to send such an indication to the first data analytics platform (and/or to the given asset, if the first data analytics platform is located elsewhere) at least in circumstances when the first precursor analysis model predicts that the first type of problem is present at the given asset, where some local action is deemed warranted by the second data analytics platform, and perhaps also in circumstances when the first precursor analysis model predicts that the first type of problem is not present at the given asset.

As another example, the action may be to send an indication of the results of second data analytics platform's deeper analysis to a client station associated with the second data analytics platform (e.g., data indicating the first precursor analysis model's prediction as to whether the first type of problem is present at the given asset). In practice, the second data analytics platform may be configured to send such an indication to a client station at least in circumstances where the first precursor analysis model predicts that the first type of problem is present at the given asset, and perhaps also in circumstances where the first precursor analysis model predicts that the first type of problem is not present at the given asset.

As yet another example, if the first precursor analysis model predicts that the first type of problem is not present at the given asset, the action may be to store the data associated with the first precursor event occurrence of the first type into a database that is later used to evaluate and potentially update the precursor detection and/or precursor analysis models being used. For instance, based on an evaluation of precursor event occurrences of the first type that did not lead to a prediction of any problem being present at an asset, the second data analytics platform may determine either that the first type of precursor event is not a sufficiently accurate indicator of a problem at an asset (such that the corresponding precursor detection model can be disabled), or that the first type of precursor event is indicative of a new type of problem for which a new precursor analysis model needs to be defined. The second data analytics platform's evaluation of precursor event occurrences of the first type that did not lead to a prediction of any problem being present at an asset may take other forms as well.

As still another example, based on the first precursor analysis model's output, the second data analytics platform may trigger additional analysis to be performed by the first and/or second data analytics platform (and/or by a local analytics device at the given asset itself, if the first data analytics platform is located elsewhere). In this respect, the location where the additional analysis is performed may be dictated by various considerations, examples of which may include (1) the location(s) where the data to be used for the additional analysis is accessible (e.g., a local analytics system may potentially have full access to asset-generated data but limited or no access to non-asset generated contextual data sources, whereas a remote analytics system may have full access to non-asset generated contextual data sources but only limited or no access to certain types of asset-generated data) and (2) the available compute resources at the different locations (e.g., a local analytics system may be constrained in multiple ways, including lack of physical compute capacity, restricted access to asset-generated data due to potential risk of disrupting asset behavior when accessing data from it, etc., whereas a remote analytics system may generally have more widely-available compute resources).

Further, the additional analysis triggered based on the first precursor analysis model's output may take various forms. As one possibility, based on the first precursor analysis model's output, the second data analytics platform may cause one or more other predictive models to be executed by the first and/or second data analytics platform that may not otherwise be executed (i.e., the first and/or second data analytics platform may execute the one or more predictive models “on demand”). Many other actions are possible as well.

The approach disclosed herein may thus enable the execution of predictive models related to an asset's operation to be distributed between multiple data analytics platforms, where a first data analytics platform functions to perform a preliminary analysis of the asset's operation based on the operating data for the asset and then trigger at least a second data analytics platform to perform a deeper analysis of the asset's operation in circumstances where the first data analytics platform's preliminary analysis indicates that a potential problem may be present at the asset. Such an approach provides several advantages.

As one example, the disclosed approach may lead to a reduction in the amount of operating data that is sent from the source of the data on which the predictive model is based to a remote data analytics platform (e.g., by only sending data associated with precursor event occurrences), which may in turn reduce transmission costs and/or data retention costs. As another example, the disclosed approach may enable a local or remote data analytics platform to execute predictive models related to an asset's operation on an “as needed” (or “on demand”) basis rather than on a continuous basis, which may in turn reduce the computing resources that are required in order to evaluate the asset's operation. The disclosed approach may lead to several other advantages as well.

There are also several possible variations and extensions of the approach disclosed herein. For instance, in one embodiment, the set of one or more precursor detection models and the set of one or more precursor analysis models could be implemented by the same data analytics platform, rather than two different data analytics platforms. In other words, in such an embodiment, the first data analytics platform (e.g., a local analytics device at the given asset) may be configured to execute the set of one or more precursor analysis models on an “as needed” basis as precursor event occurrences are detected by the first data analytics platform, which may avoid the need to transmit data indicating precursor event occurrences to a second data analytics platform during normal operation.

In another embodiment, in addition (or in alternative) to being provisioned with the set of one or more precursor detection models, the first data analytics platform (e.g., a local analytics device at the given asset) may be provisioned with a set of one or more predictive models that are each configured to predict whether a respective type of problem is present at the given asset, such as a failure or a signal anomaly. In practice, each of these predictive models may be a “simplified” (or “approximated”) version of a corresponding predictive model available at the second data analytics platform (e.g., in terms of the complexity of the precursor model and/or the set of data that is input into the precursor model). In such an embodiment, a simplified model's prediction that a problem is present at the given asset may be reported by the first data analytics platform to the second data analytics platform, which may in turn trigger the second data analytics platform to identify and execute the corresponding model in order to perform a deeper analysis of the first data analytics platform's prediction and thereby verify whether that prediction is accurate. After performing this deeper analysis of the first data analytics platform's prediction of a problem at the given asset, the second data analytics platform may then take actions similar to those described above.

In yet another embodiment, a process similar to that described above may be carried out in an arrangement that includes three data analytics platforms. For example, a first data analytics platform located at a given asset may be configured to execute a precursor detection model and communicate the results to a second data analytics platform located at a job site, which may be configured to receive and aggregate data from a plurality of assets at the job site and then execute precursor analysis models based on such data. In turn, the second data analytics platform may be configured to communicate the results of its precursor analysis models to a third data analytics platform located remotely from the job site, which may be configured to execute precursor analysis models based on the data received from the second data analytics platform as well as other contextual data.

Other variations and extensions of the disclosed approach may exist as well.

Accordingly, in one aspect, disclosed herein is a method of operation of a given data analytics platform that involves (1) receiving, from at least a first other data analytics platform that is provisioned with a set of one or more precursor detection models related to asset operation, data associated with a given occurrence of a given type of precursor event at a given asset that is detected by the first other data analytics platform using a given precursor detection model of the set of one or more precursor detection models, (2) in response to receiving the data associated with the given occurrence of the given type of precursor event, (a) identifying, from a set of one or more precursor analysis models available to be executed at the given data analytics platform, at least one precursor analysis model that is associated with the given type of precursor event and predicts whether a given type of problem is present at an asset and (b) executing the at least one precursor analysis model to perform a deeper analysis of the given occurrence of the given type of precursor event and thereby output a prediction of whether the given type of problem is present at the given asset, and (3) taking one or more actions based on the prediction of whether the given type of problem is present at the given asset.

In this respect, the given data analytics platform may include a network interface configured to communicatively couple the given data analytics platform to the first other data analytics platform, at least one processor, a non-transitory computer-readable medium, and program instructions stored on the non-transitory computer-readable medium that are executable by the at least one processor to cause the given data analytics platform to carry out such a method.

Also disclosed herein is a system that includes a first data analytics platform that is provisioned with a set of one or more precursor detection models related to asset operation and a second data analytics platform that is provisioned with a set of one or more precursor analysis models related to asset operation. In such a system, the first data analytics platform may comprise a non-transitory computer-readable medium having instructions stored thereon that are executable to cause the first data analytics platform to (a) execute the set of one or more precursor detection models, (b) based on a given precursor detection model of the set of one or more precursor detection models, detect a given occurrence of a given type of precursor event at a given asset, (c) send data associated with the given occurrence of the given type of precursor event at the given asset to the second data analytics platform, and perhaps also (d) trigger additional analysis by the first data analytics platform not generally performed unless a given precursor condition has been detected. Further, the second data analytics platform may comprise a non-transitory computer-readable medium having instructions stored thereon that are executable to cause the second data analytics platform to (a) receive, from the first other data analytics platform, the data associated with the given occurrence of the given type of precursor event at the given asset, (b) in response to receiving the data associated with the given occurrence of the given type of precursor event, (i) identify, from the set of one or more precursor analysis models, at least one precursor analysis model that is associated with the given type of precursor event and predicts whether a given type of problem is present at an asset and (ii) execute the at least one precursor analysis model to perform a deeper analysis of the given occurrence of the given type of precursor event and thereby output a prediction of whether the given type of problem is present at the given asset, and (c) take one or more actions based on the prediction of whether the given type of problem is present at the given asset.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts a simplified block diagram of an example asset.

FIG. 3 depicts a conceptual illustration of example abnormal-condition indicators and triggering criteria.

FIG. 4 depicts a simplified block diagram of an example data analytics platform.

FIG. 5 depicts a functional block diagram of an example data analytics platform.

FIG. 6 depicts a flow diagram of an example method for distributing execution of a predictive model between multiple data analytics platforms.

### DETAILED DESCRIPTION

The following disclosure makes reference to the accompanying figures and several exemplary embodiments. One of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. EXAMPLE NETWORK CONFIGURATION

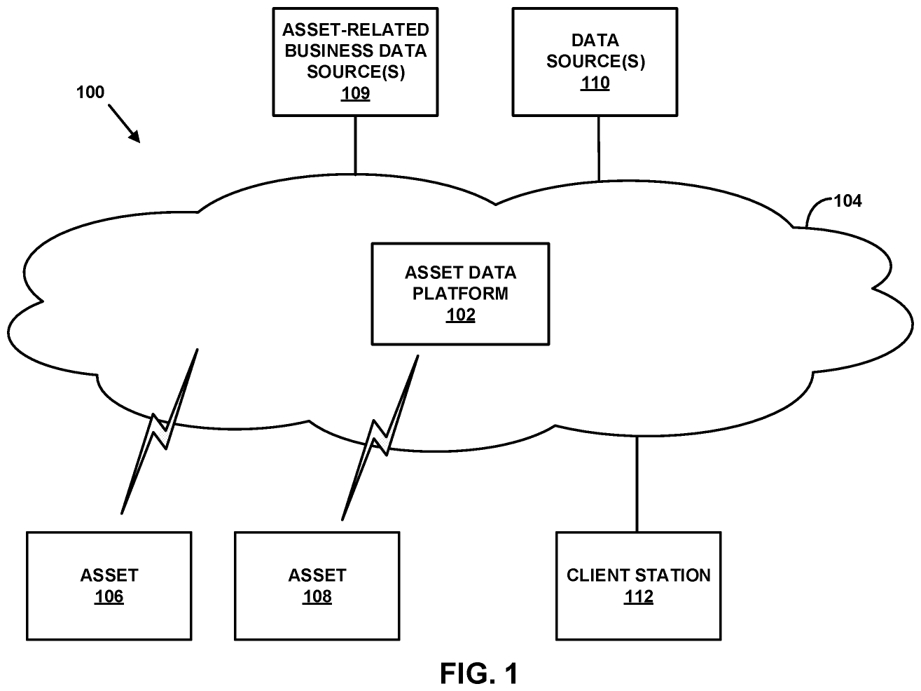

Turning now to the figures, FIG. 1 depicts an example network configuration 100 in which example embodiments may be implemented. As shown, the network configuration 100 includes a remote data analytics system 102 that may be configured as an asset data platform, which may communicate via a communication network 104 with one or more assets that are equipped with local analytics devices, such as representative assets 106 and 108, one or more data sources, such as asset-related business data source 109 and representative data source 110, and one or more output systems, such as representative client station 112. It should be understood that the network configuration may include various other systems as well.

Broadly speaking, the asset data platform 102 may take the form of one or more computer systems that are configured to receive, ingest, process, analyze, and/or provide access to asset-related data. For instance, a platform may include one or more servers (or the like) having hardware components and software components that are configured to carry out one or more of the functions disclosed herein for receiving, ingesting, processing, analyzing, and/or providing access to asset-related data. Additionally, a platform may include one or more user interface components that enable a platform user to interface with the platform. In practice, these computing systems may be located in a single physical location or distributed amongst a plurality of locations, and may be communicatively linked via a system bus, a communication network (e.g., a private network), or some other connection mechanism. Further, the platform may be arranged to receive and transmit data according to dataflow technology, such as TPL Dataflow or NiFi, among other examples. The platform may take other forms as well.

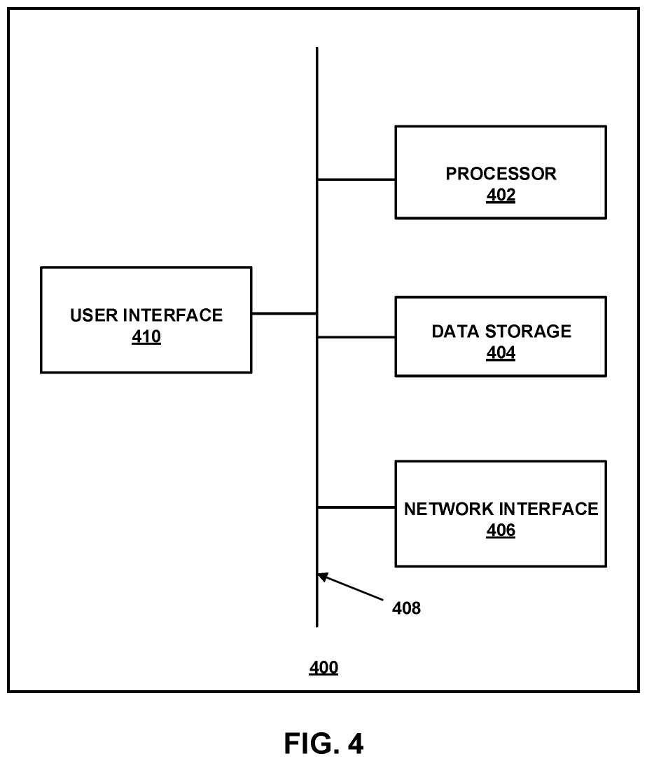

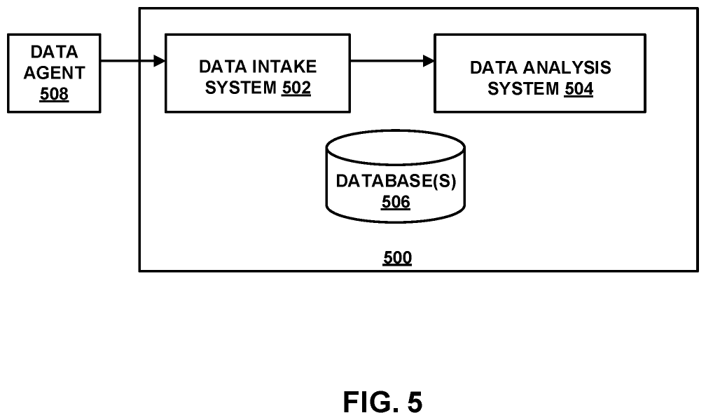

In some implementations, the asset data platform 102 may comprise computing infrastructure that is part of an Internet-accessible, public, private, or hybrid cloud. However, in other implementations, the asset data platform 102 may comprise one or more dedicated servers, and/or may take other forms as well. The asset data platform 102 is discussed in further detail below with reference to FIGS. 4-5.

As shown in FIG. 1, the asset data platform 102 may be configured to communicate, via the communication network 104, with the one or more assets, data sources, and/or output systems in the network configuration 100. For example, the asset data platform 102 may receive asset-related data, via the communication network 104, that is sent by one or more assets and/or data sources. As another example, the asset data platform 102 may transmit asset-related data and/or commands, via the communication network 104, for receipt by an output system, such as a client station, a work-order system, a parts-ordering system, etc. The asset data platform 102 may engage in other types of communication via the communication network 104 as well.

In general, the communication network 104 may include one or more computing systems and network infrastructure configured to facilitate transferring data between asset data platform 102 and the one or more assets, data sources, and/or output systems in the network configuration 100. The communication network 104 may be or may include connectivity capabilities provided by one or more public, private or hybrid clouds, Wide-Area Networks (WANs), Local-Area Networks (LANs) and/or operational technology (OT) networks, which may be wired and/or wireless and may support secure communication. In some examples, the communication network 104 may include one or more cellular networks and/or the Internet, among other networks. The communication network 104 may operate according to one or more communication protocols, such as LTE, CDMA, GSM, LPWAN, WiFi, Bluetooth, Ethernet, HTTP/S, TCP/TLS, CoAP/DTLS, 802.15.4, Serial, CAN, WirelessHART, and the like. Although the communication network 104 is shown as a single network, it should be understood that the communication network 104 may include multiple, distinct networks that are themselves communicatively linked. Further, in example cases, the communication network 104 may facilitate secure communications between network components (e.g., via encryption or other security measures). The communication network 104 could take other forms as well.

Although not shown, the communication path between the asset data platform 102 and the one or more assets, data sources, and/or output systems may include one or more intermediate systems. For example, the one or more assets and/or data sources may send asset-related data to one or more intermediary systems, such as an asset gateway or an organization's existing platform (not shown), and the asset data platform 102 may then be configured to receive data from the one or more intermediary systems. In this respect, the one or more intermediary systems may include an intermediate data analytics platform, such as a data analytics platform located at a job site where assets 106 and 108 are also located. As another example, the asset data platform 102 may communicate with an output system via one or more intermediary systems, such as a host server (not shown). Many other configurations are also possible.

In general, the assets 106 and 108 may take the form of any device configured to perform one or more operations (which may be defined based on the field) and may also include equipment configured to transmit data indicative of the asset's attributes, such as the operation and/or configuration of the given asset. This data may take various forms, examples of which may include signal data (e.g., sensor/actuator data), fault data (e.g., fault codes), location data for the asset, identifying data for the asset, etc.

Representative examples of asset types may include transportation machines (e.g., locomotives, aircrafts, passenger vehicles, semi-trailer trucks, ships, etc.), industrial machines (e.g., mining equipment, construction equipment, processing equipment, assembly equipment, etc.), medical machines (e.g., medical imaging equipment, surgical equipment, medical monitoring systems, medical laboratory equipment, etc.), utility machines (e.g., wind turbines, solar farms, etc.), unmanned aerial vehicles, and data network nodes (e.g., personal computers, routers, bridges, gateways, switches, etc.), among other examples. Additionally, the assets of each given type may have various different configurations (e.g., brand, make, model, software version, etc.).

As such, in some examples, the assets 106 and 108 may each be of the same type (e.g., a fleet of locomotives, tractors, aircrafts, etc., a group of wind turbines, a pool of milling machines, or a set of magnetic resonance imagining (MRI) machines, among other examples) and perhaps may have the same configuration (e.g., the same brand, make, model, firmware version, etc.). In other examples, the assets 106 and 108 may have different asset types or different configurations (e.g., different brands, makes, models, and/or software versions). For instance, assets 106 and 108 may be different pieces of equipment at a job site (e.g., an excavation site) or a production facility, or different nodes in a data network, among numerous other examples. Those of ordinary skill in the art will appreciate that these are but a few examples of assets and that numerous others are possible and contemplated herein.

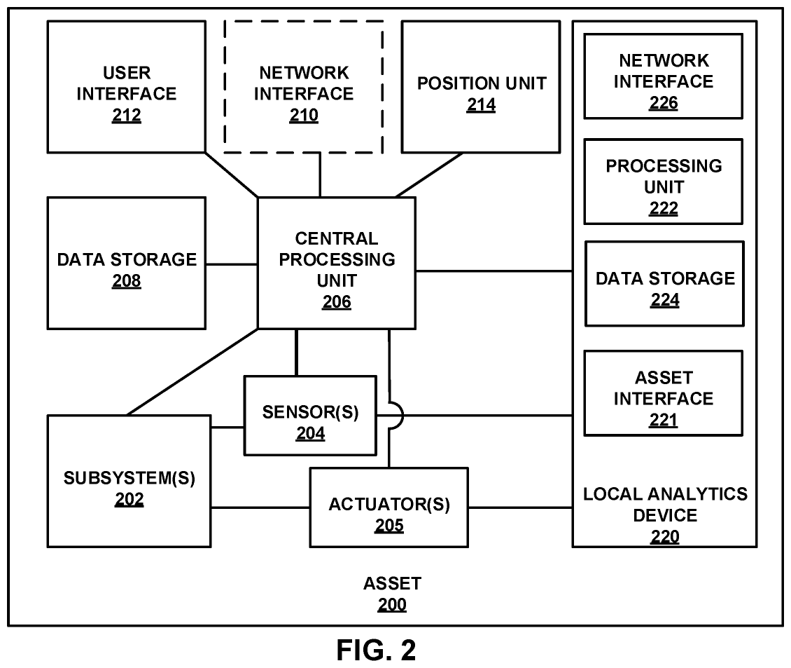

Depending on an asset's type and/or configuration, the asset may also include one or more subsystems configured to perform one or more respective operations. For example, in the context of transportation assets, subsystems may include engines, transmissions, drivetrains, fuel systems, battery systems, exhaust systems, braking systems, electrical systems, signal processing systems, generators, gear boxes, rotors, and hydraulic systems, among numerous other examples. In practice, an asset's multiple subsystems may operate in parallel or sequentially in order for an asset to operate. Representative assets are discussed in further detail below with reference to FIG. 2.

In general, the asset-related business data source 109 may include one or more computing systems configured to collect, store, and/or provide asset-related business data that may be produced and consumed across a given organization. In some instances, asset-related business data may include various categories that are classified according to the given organization's process, resources, and/or standards. In one example, asset-related business data may include point-of-sale (POS) data, customer relationship management (CRM) data, and/or enterprise resource planning (ERP) data, as examples. Asset-related business data may also include broader categories of data, such inventory data, location data, financial data, employee data, and maintenance data, among other categories. In operation, the asset data platform 102 may be configured to receive data from the asset-related business data source 109 via the communication network 104. In turn, the asset data platform 102 may store, provide, and/or analyze the received enterprise data.

The data source 110 may also include one or more computing systems configured to collect, store, and/or provide data that is related to the assets or is otherwise relevant to the functions performed by the asset data platform 102. For example, the data source 110 may collect and provide operating data that originates from the assets (e.g., historical operating data), in which case the data source 110 may serve as an alternative source for such asset operating data. As another example, the data source 110 may be configured to provide data that does not originate from the assets, which may be referred to herein as “external data.” Such a data source may take various forms.

In one implementation, the data source 110 could take the form of an environment data source that is configured to provide data indicating some characteristic of the environment in which assets are operated. Examples of environment data sources include weather-data servers, global navigation satellite systems (GNSS) servers, map-data servers, and topography-data servers that provide information regarding natural and artificial features of a given area, among other examples.

In another implementation, the data source 110 could take the form of asset-management data source that provides data indicating events or statuses of entities (e.g., other assets) that may affect the operation or maintenance of assets (e.g., when and where an asset may operate or receive maintenance). Examples of asset-management data sources include asset-maintenance servers that provide information regarding inspections, maintenance, services, and/or repairs that have been performed and/or are scheduled to be performed on assets, traffic-data servers that provide information regarding air, water, and/or ground traffic, asset-schedule servers that provide information regarding expected routes and/or locations of assets on particular dates and/or at particular times, defect detector systems (also known as “hotbox” detectors) that provide information regarding one or more operating conditions of an asset that passes in proximity to the defect detector system, and part-supplier servers that provide information regarding parts that particular suppliers have in stock and prices thereof, among other examples.

The data source 110 may also take other forms, examples of which may include fluid analysis servers that provide information regarding the results of fluid analyses and power-grid servers that provide information regarding electricity consumption, among other examples. One of ordinary skill in the art will appreciate that these are but a few examples of data sources and that numerous others are possible.

In practice, the asset data platform 102 may receive data from the data source 110 by “subscribing” to a service provided by the data source. However, the asset data platform 102 may receive data from the data source 110 in other manners as well.

The client station 112 may take the form of a computing system or device configured to access and enable a user to interact with the asset data platform 102. To facilitate this, the client station may include hardware components such as a user interface, a network interface, a processor, and data storage, among other components. Additionally, the client station may be configured with software components that enable interaction with the asset data platform 102, such as a web browser that is capable of accessing a web application provided by the asset data platform 102 or a native client application associated with the asset data platform 102, among other examples. Representative examples of client stations may include a desktop computer, a laptop, a netbook, a tablet, a smartphone, a personal digital assistant (PDA), or any other such device now known or later developed.

Other examples of output systems may take include a work-order system configured to output a request for a mechanic or the like to repair an asset or a parts-ordering system configured to place an order for a part of an asset and output a receipt thereof, among others.

It should be understood that the network configuration 100 is one example of a network in which embodiments described herein may be implemented. Numerous other arrangements are possible and contemplated herein. For instance, other network configurations may include additional components not pictured and/or more or less of the pictured components.

### II. EXAMPLE ASSET

Turning to FIG. 2, a simplified block diagram of an example asset 200 is depicted. Either or both of assets 106 and 108 from FIG. 1 may be configured like the asset 200. As shown, the asset 200 may include one or more subsystems 202, one or more sensors 204, one or more actuators 205, a central processing unit 206, data storage 208, a network interface 210, a user interface 212, a position unit 214, and a local analytics device 220, all of which may be communicatively linked (either directly or indirectly) by a system bus, network, or other connection mechanism. One of ordinary skill in the art will appreciate that the asset 200 may include additional components not shown and/or more or less of the depicted components. Further, one of ordinary skill in the art will appreciate that two or more of the components of the asset 200 may be integrated together in whole or in part. Further yet, one of ordinary skill in the art will appreciate that at least some of these components of the asset 200 may be affixed and/or otherwise added to the asset 200 after it has been placed into operation.

Broadly speaking, the asset 200 may include one or more electrical, mechanical, electromechanical components, and/or electronic components that are configured to perform one or more operations. In some cases, one or more components may be grouped into a given subsystem 202.

Generally, a subsystem 202 may include a group of related components that are part of the asset 200. A single subsystem 202 may independently perform one or more operations or the single subsystem 202 may operate along with one or more other subsystems to perform one or more operations. Typically, different types of assets, and even different classes of the same type of assets, may include different subsystems. Representative examples of subsystems are discussed above with reference to FIG. 1.

As suggested above, the asset 200 may be outfitted with various sensors 204 that are configured to monitor operating conditions of the asset 200 and various actuators 205 that are configured to interact with the asset 200 or a component thereof and monitor operating conditions of the asset 200. In some cases, some of the sensors 204 and/or actuators 205 may be grouped based on a particular subsystem 202. In this way, the group of sensors 204 and/or actuators 205 may be configured to monitor operating conditions of the particular subsystem 202, and the actuators from that group may be configured to interact with the particular subsystem 202 in some way that may alter the subsystem's behavior based on those operating conditions.

In general, a sensor 204 may be configured to detect a physical property, which may be indicative of one or more operating conditions of the asset 200, and provide an indication, such as an electrical signal (e.g., “signal data”), of the detected physical property. In operation, the sensors 204 may be configured to obtain measurements continuously, periodically (e.g., based on a sampling frequency), and/or in response to some triggering event. In some examples, the sensors 204 may be preconfigured with operating parameters for performing measurements and/or may perform measurements in accordance with operating parameters provided by the central processing unit 206 (e.g., sampling signals that instruct the sensors 204 to obtain measurements). In examples, different sensors 204 may have different operating parameters (e.g., some sensors may sample based on a first frequency, while other sensors sample based on a second, different frequency). In any event, the sensors 204 may be configured to transmit electrical signals indicative of a measured physical property to the central processing unit 206. The sensors 204 may continuously or periodically provide such signals to the central processing unit 206.

For instance, sensors 204 may be configured to measure physical properties such as the location and/or movement of the asset 200, in which case the sensors may take the form of GNSS sensors, dead-reckoning-based sensors, accelerometers, gyroscopes, pedometers, magnetometers, or the like. In example embodiments, one or more such sensors may comprise and/or be integrated with the position unit 214, which is discussed in further detail below.

Additionally, various sensors 204 may be configured to measure other operating conditions of the asset 200, examples of which may include temperatures, pressures, speeds, acceleration or deceleration rates, friction, power usages, throttle positions, fuel usages, fluid levels, runtimes, voltages and currents, magnetic fields, electric fields, presence or absence of objects, positions of components, and power generation, among other examples. One of ordinary skill in the art will appreciate that these are but a few example operating conditions that sensors may be configured to measure. Additional or fewer sensors may be used depending on the industrial application or specific asset.

As suggested above, an actuator 205 may be configured similar in some respects to a sensor 204. Specifically, an actuator 205 may be configured to detect a physical property indicative of an operating condition of the asset 200 and provide an indication thereof in a manner similar to the sensor 204.

Moreover, an actuator 205 may be configured to interact with the asset 200, one or more subsystems 202, and/or some component thereof. As such, an actuator 205 may include a motor or the like that is configured to perform a mechanical operation (e.g., move) or otherwise control a component, subsystem, or system. In a particular example, an actuator may be configured to measure a fuel flow and alter the fuel flow (e.g., restrict the fuel flow), or an actuator may be configured to measure a hydraulic pressure and alter the hydraulic pressure (e.g., increase or decrease the hydraulic pressure). Numerous other example interactions of an actuator are also possible and contemplated herein.

Depending on the asset's type and/or configuration, it should be understood that the asset 200 may additionally or alternatively include other components and/or mechanisms for monitoring the operation of the asset 200. As one possibility, the asset 200 may employ software-based mechanisms for monitoring certain aspects of the asset's operation (e.g., network activity, computer resource utilization, etc.), which may be embodied as program instructions that are stored in data storage 208 and are executable by the central processing unit 206.

Generally, the central processing unit 206 may include one or more processors and/or controllers, which may take the form of a general- or special-purpose processor or controller. In particular, in example implementations, the central processing unit 206 may be or include microprocessors, microcontrollers, application specific integrated circuits, digital signal processors, graphics processing units (GPUs), and the like. In turn, the data storage 208 may be or include one or more non-transitory computer-readable storage media, such as optical, magnetic, organic, or flash memory, among other examples.

The central processing unit 206 may be configured to store, access, and execute computer-readable program instructions stored in the data storage 208 to perform the operations of an asset described herein. For instance, as suggested above, the central processing unit 206 may be configured to receive respective sensor signals from the sensors 204 and/or actuators 205. The central processing unit 206 may be configured to store sensor and/or actuator data in and later access it from the data storage 208. Additionally, the central processing unit 206 may be configured to access and/or generate data reflecting the configuration of the asset (e.g., model number, asset age, software versions installed, etc.).

The central processing unit 206 may also be configured to determine whether received sensor and/or actuator signals trigger any abnormal-condition indicators, such as fault codes, which is a form of fault data. For instance, the central processing unit 206 may be configured to store in the data storage 208 abnormal-condition rules, each of which include a given abnormal-condition indicator representing a particular abnormal condition and respective triggering criteria that trigger the abnormal-condition indicator. That is, each abnormal-condition indicator corresponds with one or more sensor and/or actuator measurement values that must be satisfied before the abnormal-condition indicator is triggered. In practice, the asset 200 may be pre-programmed with the abnormal-condition rules and/or may receive new abnormal-condition rules or updates to existing rules from a computing system, such as the asset data platform 102.

In any event, the central processing unit 206 may be configured to determine whether received sensor and/or actuator signals trigger any abnormal-condition indicators. That is, the central processing unit 206 may determine whether received sensor and/or actuator signals satisfy any triggering criteria. When such a determination is affirmative, the central processing unit 206 may generate abnormal-condition data and then may also cause the asset's network interface 210 to transmit the abnormal-condition data to the asset data platform 102 and/or cause the asset's user interface 212 to output an indication of the abnormal condition, such as a visual and/or audible alert. Additionally, the central processing unit 206 may log the occurrence of the abnormal-condition indicator being triggered in the data storage 208, perhaps with a timestamp.

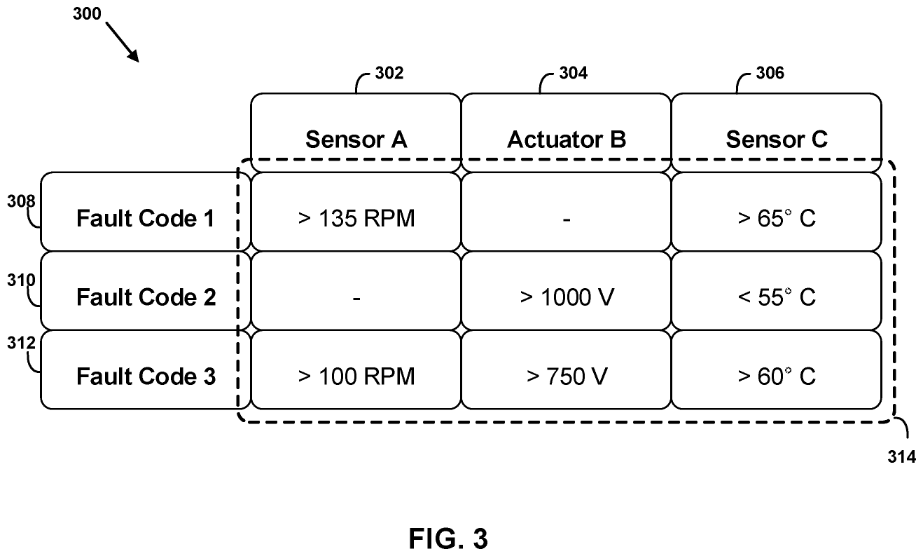

FIG. 3 depicts a conceptual illustration of example abnormal-condition indicators and respective triggering criteria for an asset. In particular, FIG. 3 depicts a conceptual illustration of example fault codes. As shown, table 300 includes columns 302, 304, and 306 that correspond to Sensor A, Actuator B, and Sensor C, respectively, and rows 308, 310, and 312 that correspond to Fault Codes 1, 2, and 3, respectively. Entries 314 then specify sensor criteria (e.g., sensor value thresholds) that correspond to the given fault codes.

For example, Fault Code 1 will be triggered when Sensor A detects a rotational measurement greater than 135 revolutions per minute (RPM) and Sensor C detects a temperature measurement greater than 65° Celsius (C), Fault Code 2 will be triggered when Actuator B detects a voltage measurement greater than 1000 Volts (V) and Sensor C detects a temperature measurement less than 55° C., and Fault Code 3 will be triggered when Sensor A detects a rotational measurement greater than 100 RPM, Actuator B detects a voltage measurement greater than 750 V, and Sensor C detects a temperature measurement greater than 60° C. One of ordinary skill in the art will appreciate that FIG. 3 is provided for purposes of example and explanation only and that numerous other fault codes and/or triggering criteria are possible and contemplated herein.

Referring back to FIG. 2, the central processing unit 206 may be configured to carry out various additional functions for managing and/or controlling operations of the asset 200 as well. For example, the central processing unit 206 may be configured to provide instruction signals to the subsystems 202 and/or the actuators 205 that cause the subsystems 202 and/or the actuators 205 to perform some operation, such as modifying a throttle position. Additionally, the central processing unit 206 may be configured to modify the rate at which it processes data from the sensors 204 and/or the actuators 205, or the central processing unit 206 may be configured to provide instruction signals to the sensors 204 and/or actuators 205 that cause the sensors 204 and/or actuators 205 to, for example, modify a sampling rate. Moreover, the central processing unit 206 may be configured to receive signals from the subsystems 202, the sensors 204, the actuators 205, the network interfaces 210, the user interfaces 212, and/or the position unit 214, and based on such signals, cause an operation to occur. Further still, the central processing unit 206 may be configured to receive signals from a computing device, such as a diagnostic device, that cause the central processing unit 206 to execute one or more diagnostic tools in accordance with diagnostic rules stored in the data storage 208. Other functionalities of the central processing unit 206 are discussed below.

The network interface 210 may be configured to provide for communication between the asset 200 and various network components connected to the communication network 104. For example, the network interface 210 may be configured to facilitate wireless communications to and from the communication network 104 and may thus take the form of an antenna structure and associated equipment for transmitting and receiving various over-the-air signals. Other examples are possible as well. In practice, the network interface 210 may be configured according to a communication protocol, such as but not limited to any of those described above.

The user interface 212 may be configured to facilitate user interaction with the asset 200 and may also be configured to facilitate causing the asset 200 to perform an operation in response to user interaction. Examples of user interfaces 212 include touch-sensitive interfaces, mechanical interfaces (e.g., levers, buttons, wheels, dials, keyboards, etc.), and other input interfaces (e.g., microphones), among other examples. In some cases, the user interface 212 may include or provide connectivity to output components, such as display screens, speakers, headphone jacks, and the like.

Position unit 214 may be generally configured to facilitate performing functions related to geo-spatial location/position and/or navigation. More specifically, position unit 214 may be configured to facilitate determining the location/position of asset 200 and/or tracking the movements of asset 200 via one or more positioning technologies, such as a GNSS technology (e.g., GPS, GLONASS, Galileo, BeiDou, or the like), triangulation technology, and the like. As such, position unit 214 may include one or more sensors and/or receivers that are configured according to one or more particular positioning technologies.

In example embodiments, position unit 214 may allow the asset 200 to provide to other systems and/or devices (e.g., asset data platform 102) position data that indicates the position of the asset 200, which may take the form of GPS coordinates, among other forms. In some implementations, asset 200 may provide position data to other systems continuously, periodically, based on triggers, or in some other manner. Moreover, asset 200 may provide position data independent of or along with other asset-related data (e.g., as part of the asset's operating data).

The local analytics device 220 may generally be configured to receive and analyze data related to the asset 200 and based on such analysis, may cause one or more operations to occur at the asset 200. For example, the local analytics device 220 may receive operating data for the asset 200 (e.g., signal data generated by the sensors 204 and/or actuators 205) and based on such data, may provide instructions to the central processing unit 206, the sensors 204, and/or the actuators 205 that cause the asset 200 to perform an operation. In another example, the local analytics device 220 may receive location data from the position unit 214 and based on such data, may modify how it handles predictive models and/or workflows for the asset 200. In yet another example, the local analytics device 220 may receive data related to the asset 200 from other data sources that are not physically part of the asset itself, such as external data sources. Other example analyses and corresponding operations are also possible.

It should also be understood that the local analytics device 220 may include its own integrated sensors, its own integrated actuators, and/or its own integrated position unit, in which case the local analytics device 220 may be configured to receive and analyze data from these integrated components in addition to (or in alternative to) the sensors 204, actuators 205, and/or position unit 214 of the asset 200.

To facilitate some of these operations, the local analytics device 220 may include one or more asset interfaces that are configured to couple the local analytics device 220 to one or more of the asset's on-board systems. For instance, as shown in FIG. 2, the local analytics device 220 may have an interface to the asset's central processing unit 206, which may enable the local analytics device 220 to receive data from the central processing unit 206 (e.g., operating data that is generated by sensors 204 and/or actuators 205 and sent to the central processing unit 206) and then provide instructions to the central processing unit 206. In this way, the local analytics device 220 may indirectly interface with and receive data from other on-board systems of the asset 200 (e.g., the sensors 204 and/or actuators 205) via the central processing unit 206. Additionally or alternatively, as shown in FIG. 2, the local analytics device 220 could have an interface to one or more sensors 204 and/or actuators 205, which may enable the local analytics device 220 to communicate directly with the sensors 204 and/or actuators 205. The local analytics device 220 may interface with the on-board systems of the asset 200 in other manners as well, including the possibility that the interfaces illustrated in FIG. 2 are facilitated by one or more intermediary systems that are not shown.

In practice, the local analytics device 220 may enable the asset 200 to locally perform advanced analytics and associated operations, such as executing a predictive model and corresponding workflow, that may otherwise not be able to be performed with the other on-asset components. As such, the local analytics device 220 may help provide additional processing power and/or intelligence to the asset 200.

It should be understood that the local analytics device 220 may also be configured to cause the asset 200 to perform operations that are not related to a predictive model. For example, the local analytics device 220 may receive data from a remote source, such as the asset data platform 102 or the output system 112, and based on the received data cause the asset 200 to perform one or more operations. One particular example may involve the local analytics device 220 receiving a firmware update for the asset 200 from a remote source and then causing the asset 200 to update its firmware. Another particular example may involve the local analytics device 220 receiving a diagnosis instruction from a remote source and then causing the asset 200 to execute a local diagnostic tool in accordance with the received instruction. Numerous other examples are also possible.

As shown, in addition to the one or more asset interfaces discussed above, the local analytics device 220 may also include a processing unit 222, a data storage 224, and a network interface 226, all of which may be communicatively linked by a system bus, network, or other connection mechanism. The processing unit 222 may include any of the components discussed above with respect to the central processing unit 206. In turn, the data storage 224 may be or include one or more non-transitory computer-readable storage media, which may take any of the forms of computer-readable storage media discussed above.

The processing unit 222 may be configured to store, access, and execute computer-readable program instructions stored in the data storage 224 to perform the operations of a local analytics device described herein. For instance, the processing unit 222 may be configured to receive respective sensor and/or actuator signals generated by the sensors 204 and/or actuators 205 and may execute a predictive model and corresponding workflow based on such signals. Other functions are described below.

The network interface 226 may be the same or similar to the network interfaces described above. In practice, the network interface 226 may facilitate communication between the local analytics device 220 and the asset data platform 102.

In some example implementations, the local analytics device 220 may include and/or communicate with a user interface that may be similar to the user interface 212. In practice, the user interface may be located remote from the local analytics device 220 (and the asset 200). Other examples are also possible.

While FIG. 2 shows the local analytics device 220 physically and communicatively coupled to its associated asset (e.g., the asset 200) via one or more asset interfaces, it should also be understood that this might not always be the case. For example, in some implementations, the local analytics device 220 may not be physically coupled to its associated asset and instead may be located remote from the asset 200. In an example of such an implementation, the local analytics device 220 may be wirelessly, communicatively coupled to the asset 200. Other arrangements and configurations are also possible.

For more detail regarding the configuration and operation of a local analytics device, please refer to U.S. application Ser. No. 14/963,207, which is incorporated by reference herein in its entirety.

One of ordinary skill in the art will appreciate that the asset 200 shown in FIG. 2 is but one example of a simplified representation of an asset and that numerous others are also possible. For instance, depending on the asset type, other assets may include additional components not pictured, may have more or less of the pictured components, and/or the aforementioned components may be arranged and/or integrated in a different manner (e.g., instead of having a position unit 214 affixed to the asset itself, the position unit 214 may be included as part of the local analytics device 220). Moreover, a given asset may include multiple, individual assets that are operated in concert to perform operations of the given asset. Other examples are also possible.

### III. EXAMPLE DATA ANALYTICS PLATFORM

FIG. 4 is a simplified block diagram illustrating some components that may be included in an example data analytics platform 400 from a structural perspective. In line with the discussion above, the data analytics platform 400 may generally comprise one or more computer systems (e.g., one or more servers), and these one or more computer systems may collectively include at least a processor 402, data storage 404, network interface 406, and perhaps also a user interface 410, all of which may be communicatively linked by a communication link 408 that may take the form of a system bus, a communication network such as a public, private, or hybrid cloud, or some other connection mechanism.

The processor 402 may include one or more processors and/or controllers, which may take the form of a general- or special-purpose processor or controller. In particular, in example implementations, the processing unit 402 may include microprocessors, microcontrollers, application-specific integrated circuits, digital signal processors, and the like. In line with the discussion above, it should also be understood that the processor 402 may comprise processing components that are distributed across a plurality of physical computing devices connected via a network, such as a computing cluster a public, private, or hybrid cloud, and may include tools like DC/OS that help elastically coordinate distributed computing activities across those physical computing devices.

In turn, data storage 404 may comprise one or more non-transitory computer-readable storage mediums, examples of which may include volatile storage mediums such as random access memory, registers, cache, etc. and non-volatile storage mediums such as read-only memory, a hard-disk drive, a solid-state drive, flash memory, an optical-storage device, etc. In line with the discussion above, it should also be understood that the data storage 204 may comprise computer-readable storage mediums that are distributed across a plurality of physical computing devices connected via a network, such as a storage cluster of a public, private, or hybrid cloud that operates according to technology such as Amazon Web Services for Elastic Compute Cloud, Simple Storage Service, etc.

As shown in FIG. 4, the data storage 404 may be provisioned with software components that enable the platform 400 to carry out the functions disclosed herein. These software components may generally take the form of program instructions that are executable by the processor 402, and may be arranged together into applications, software development kits, toolsets, or the like. In addition, the data storage 404 may also be provisioned with one or more databases that are arranged to store data related to the functions carried out by the platform, examples of which include time-series databases, document databases, relational databases (e.g., MySQL), key-value databases, and graph databases, among others. The one or more databases may also provide for poly-glot storage.

The network interface 406 may be configured to facilitate wireless and/or wired communication between the platform 400 and various network components via the communication network 104, such as assets 106 and 108, data source 110, and client station 112. Additionally, in an implementation where the data analytics platform 400 comprises a plurality of physical computing devices connected via a network, the network interface 206 may be configured to facilitate wireless and/or wired communication between these physical computing devices (e.g., between computing and storage clusters in a public, private or hybrid cloud). As such, network interface 406 may take any suitable form for carrying out these functions, examples of which may include an Ethernet interface, a serial bus interface (e.g., Firewire, USB 2.0, etc.), a chipset and antenna adapted to facilitate wireless communication, and/or any other interface that provides for wired and/or wireless communication. Network interface 406 may also include multiple network interfaces that support various different types of network connections, some examples of which may include data access, messaging or file transfer protocols, data storage and/or encoding protocols, security protocols, IP and non-IP based networking protocols, industry specific standard or de-facto standard protocols, vendor specific data transfer, encoding and storage mechanisms such as OSI PI, or operational technology protocols like IP.21, ARINC 429, Modbus, OPC or CIP over multiple transport types. Other configurations are possible as well.

The example data analytics platform 400 may also support a user interface 410 that is configured to facilitate user interaction with the platform 400 and may also be configured to facilitate causing the platform 400 to perform an operation in response to user interaction. This user interface 410 may include or provide connectivity to various input components, examples of which include touch-sensitive interfaces, mechanical interfaces (e.g., levers, buttons, wheels, dials, keyboards, etc.), and other input interfaces (e.g., microphones). Additionally, the user interface 410 may include or provide connectivity to various output components, examples of which may include display screens, speakers, headphone jacks, and the like. Other configurations are possible as well, including the possibility that the user interface 410 is embodied within a client station that is communicatively coupled to the example platform via internal or public networks, application programming interfaces (APIs), or the like.

Referring now to FIG. 5, another simplified block diagram is provided to illustrate some components that may be included in an example data analytics platform 500 from a functional perspective. For instance, as shown, the example data analytics platform 500 may include a data intake system 502 and a data analysis system 504, each of which comprises a combination of hardware and software that is configured to carry out particular functions. The data analytics platform 500 may also include a plurality of databases 506 that are included within and/or otherwise coupled to one or more of the data intake system 502 and the data analysis system 504. In practice, these functional systems may be implemented on a single computer system or distributed across a plurality of computer systems.

The data intake system 502 may generally function to receive asset-related data and then provide at least a portion of the received data to the data analysis system 504. As such, the data intake system 502 may be configured to receive asset-related data from various sources, examples of which may include an asset, an asset-related data source, or an organization's existing platform/system. The data received by the data intake system 502 may take various forms, examples of which may include analog signals, data streams, and/or network packets. Further, in some examples, the data intake system 502 may be configured according to a given dataflow technology, such as a NiFi receiver, Kafka or the like.

In some embodiments, before the data intake system 502 receives data from a given source (e.g., an asset, an organization's existing platform/system, an external asset-related data source, etc.), that source may be provisioned with a data agent 508. In general, the data agent 508 may be a software component that functions to access asset-related data at the given data source, place the data in the appropriate format, and then facilitate the transmission of that data to the data analytics platform 500 for receipt by the data intake system 502. As such, the data agent 508 may cause the given source to perform operations such as compression and/or decompression, encryption and/or de-encryption, analog-to-digital and/or digital-to-analog conversion, filtration, amplification, and/or data mapping, generation of derived data near the data source, such as statistical calculations or other useful analytics based on the originating data, among other examples. In other embodiments, however, the given data source may be capable of accessing, formatting, and/or transmitting asset-related data to the example data analytics platform 500 without the assistance of a data agent.

The asset-related data received by the data intake system 502 may take various forms. As one example, the asset-related data may include data related to the attributes of an asset in operation, which may originate from the asset itself or from an external source. This asset attribute data may include asset operating data such as signal data (e.g., sensor and/or actuator data), fault data, asset location data, weather data, hotbox data, etc. In addition, the asset attribute data may also include asset configuration data, such as data indicating the asset's brand, make, model, age, software version, etc. Asset attribute data may also include derived data generated by the data agent 508 or some other external system. As another example, the asset-related data may include certain attributes regarding the origin of the asset-related data, such as a source identifier, a timestamp (e.g., a date and/or time at which the information was obtained), and an identifier of the location at which the information was obtained (e.g., GPS coordinates). For instance, a unique identifier (e.g., a computer generated alphabetic, numeric, alphanumeric, or the like identifier) may be assigned to each asset, and perhaps to each sensor and actuator, and may be operable to identify the asset, sensor, or actuator from which data originates. These attributes may come in the form of signal signatures or metadata, among other examples. The asset-related data received by the data intake system 502 may take other forms as well.

The data intake system 502 may also be configured to perform various pre-processing functions on the asset-related data, in an effort to provide data to the data analysis system 504 that is clean, up to date, accurate, usable, etc.

For example, the data intake system 502 may map the received data into defined data structures and potentially drop any data that cannot be mapped to these data structures. As another example, the data intake system 502 may assess the reliability (or “health”) of the received data and take certain actions based on this reliability, such as dropping certain any unreliable data. As yet another example, the data intake system 502 may “de-dup” the received data by identifying any data has already been received by the platform and then ignoring or dropping such data. As still another example, the data intake system 502 may determine that the received data is related to data already stored in the platform's databases 506 (e.g., a different version of the same data) and then merge the received data and stored data together into one data structure or record. As a further example, the data intake system 502 may identify actions to be taken based on the received data (e.g., CRUD actions, data privacy actions, etc.) and then notify the data analysis system 504 of the identified actions (e.g., via HTTP headers, JSON metadata, or other methods). As still a further example, the data intake system 502 may tag or otherwise split the received data into particular data categories (e.g., by placing the different data categories into different queues). Other functions may also be performed.

In some embodiments, it is also possible that the data agent 508 may perform or assist with certain of these pre-processing functions. As one possible example, the data mapping function could be performed in whole or in part by the data agent 508 rather than the data intake system 502. Other examples are possible as well.

The data intake system 502 may further be configured to store the received asset-related data in one or more of the databases 506 for later retrieval. For example, the data intake system 502 may store the raw data received from the data agent 508 and may also store the data resulting from one or more of the pre-processing functions described above. In line with the discussion above, the databases to which the data intake system 502 stores this data may take various forms, examples of include a time-series database, document database, a relational database (e.g., MySQL), a key-value database, and a graph database, among others. Further, the databases may provide for poly-glot storage. For example, the data intake system 502 may store the payload of received asset-related data in a first type of database (e.g., a time-series or document database) and may store the associated metadata of received asset-related data in a second type of database that permit more rapid searching (e.g., a relational database). In such an example, the metadata may then be linked or associated to the asset-related data stored in the other database which relates to the metadata. The databases 506 used by the data intake system 502 may take various other forms as well.

As shown, the data intake system 502 may then be communicatively coupled to the data analysis system 504. This interface between the data intake system 502 and the data analysis system 504 may take various forms. For instance, the data intake system 502 may be communicatively coupled to the data analysis system 504 via an API. Other interface technologies are possible as well.

In one implementation, the data intake system 502 may provide, to the data analysis system 504, data that falls into three general categories: (1) signal data, (2) event data, and (3) asset configuration data. The signal data may generally take the form of raw or aggregated data representing the measurements taken by the sensors and/or actuators at the assets. The event data may generally take the form of data identifying events that relate to asset operation, such as faults and/or other asset events that correspond to indicators received from an asset (e.g., fault codes, etc.), inspection events, maintenance events, repair events, fluid events, weather events, or the like. And asset configuration information may then include information regarding the configuration of the asset, such as asset identifiers (e.g., serial number, model number, model year, etc.), software versions installed, etc. The data provided to the data analysis system 504 may also include other data and take other forms as well, including the creation or addition of derived data for any of the categories described.

The data analysis system 504 may generally function to receive data from the data intake system 502, analyze that data, and then take various actions based on that data. These actions may take various forms.

As one example, the data analysis system 504 may identify certain data that is to be output to a client station (e.g., based on a request received from the client station) and may then provide this data to the client station. As another example, the data analysis system 504 may determine that certain data satisfies a predefined rule and may then take certain actions in response to this determination, such as generating new event data or providing a notification to a user via the client station. As another example, the data analysis system 504 may use the received data to train and/or execute a predictive model related to asset operation, and the data analysis system 504 may then take certain actions based on the predictive model's output. As still another example, the data analysis system 504 may make certain data available for external access via an API.

In order to facilitate one or more of these functions, the data analysis system 504 may be configured to provide (or “drive”) a user interface that can be accessed and displayed by a client station. This user interface may take various forms. As one example, the user interface may be provided via a web application, which may generally comprise one or more web pages that can be displayed by the client station in order to present information to a user and also obtain user input. As another example, the user interface may be provided via a native client application that is installed and running on a client station but is “driven” by the data analysis system 504. The user interface provided by the data analysis system 504 may take other forms as well.

In addition to analyzing the received data for taking potential actions based on such data, the data analysis system 504 may also be configured to store the received data into one or more of the databases 506. For example, the data analysis system 504 may store the received data into a given database that serves as the primary database for providing asset-related data to platform users.

In some embodiments, the data analysis system 504 may also support a software development kit (SDK) for building, customizing, and adding additional functionality to the platform. Such an SDK may enable customization of the platform's functionality on top of the platform's hardcoded functionality.

The data analysis system 504 may perform various other functions as well. Some functions performed by the data analysis system 504 are discussed in further detail below.

One of ordinary skill in the art will appreciate that the example platform shown in FIG. 4-5 is but one example of a simplified representation of the components that may be included in a platform and that numerous others are also possible. For instance, other platforms may include additional components not pictured and/or more or less of the pictured components. Moreover, a given platform may include multiple, individual platforms that are operated in concert to perform operations of the given platform. Other examples are also possible.

### IV. EXAMPLE FUNCTIONS

As discussed above, disclosed herein are example systems, devices, and methods for distributing the execution of a predictive model between two or more data analytics platforms. Example functions that can be performed in accordance with the present disclosure will now be discussed in further detail with reference to the example network configuration 100 depicted in FIG. 1.

While the disclosed systems, devices, and methods are described at times below in the context of distributing the execution of a predictive model between a local analytics device at an asset and an asset data platform that is remote from the asset, it should be understood that this arrangement is merely described for purposes of illustration, and that the present disclosure is not limited to distributing the execution of a predictive model between an asset's local analytics device and an asset data platform. To the contrary, the disclosed systems, devices, and methods may be used in any context where it would be advantageous to distribute execution of a predictive model between multiple data analytics platforms. This includes distributed execution of a predictive model between an asset's local analytics device and a data analytics platform at the same general location as the asset (e.g., at a job site or wind farm), distributed execution of a predictive model between a data analytics platform at an asset's location and a data analytics platform that is remote from the asset (e.g., a cloud-based data analytics platform), and distributed execution of a predictive model between two local analytics devices.

In addition, the disclosed systems, devices, and methods may also be used to distribute execution of a predictive model between more than two data analytics platforms, such as distributed execution of a predictive model between three or more data analytics platforms that form a “daisy-chained” arrangement. For example, the disclosed systems, devices, and methods may also be used to distribute execution of a predictive model between a local analytics device on an asset, a data analytics platform at a job site, wind farm, or the like, and a cloud-based data analytics platform. The disclosed systems, devices, and methods may be used to in various other arrangements as well.

A. Provisioning a First Data Analytics Platform with a Set of One or More Precursor Detection Models

In accordance with the present disclosure, a first data analytics platform may be provisioned with a first set of one or more predictive models related to the operation of the given asset, referred to herein as “precursor detection models.” For instance, the given asset may be asset 106, and the first data analytics platform may be the local analytics device of asset 106. However, as noted above, the first data analytics platform could be something other than the local analytics device of the asset 106, including but not limited to a data analytics platform at a job site or the like.

Each respective precursor detection model may be a predictive model that is used by the first data analytics platform of the asset 106 to detect occurrences of a respective type of “precursor event” at the asset 106, which is a change in the operating condition of an asset that is indicative of a potential problem at the asset 106 and thus merits deeper analysis. For example, a given precursor detection model may be used to detect occurrences of a given type of precursor event that is indicative of a potential failure at the asset 106 (e.g., a failure of a given component or subsystem of given asset). As another example, a given precursor detection model may be used to detect occurrences of a given type of precursor event that is indicative of the presence of a potential signal anomaly at the asset 106. A precursor detection model may be configured to detect occurrences of a precursor event that is indicative of another type of potential problem at the asset 106 as well. (While a precursor detection model is described here as being configured to detect a single type of precursor event, it should be understood that a precursor detection model could possibly detect multiple different types of precursor events).

The types of precursor events that may be detected by the set of one or more precursor detection models may take various forms. One possible example of precursor event type may take the form of a change in the operating condition of an asset that is necessary but not sufficient for predicting that a problem is present at an asset. For instance, if a given type of problem is deemed to be present at an asset when certain asset-related data satisfies a plurality of different criteria, a precursor event may be defined as a change in an asset's operating condition that causes a first one of these criteria to be satisfied. Such a precursor event may take other forms as well.

Another possible example of precursor event type may take the form of a change in the operating condition of an asset that causes an increase in the likelihood of multiple different types of problems being present at an asset without necessarily resulting in a prediction that any one of these problems is present at the asset. For instance, if a second data analytics platform (e.g., asset data platform 102) is configured to predict the respective likelihoods of multiple different types of problems being present at an asset (e.g., via multiple different failure models, anomaly detection models, or the like), a precursor event may be defined as a change in the operating condition of an asset causes the respective likelihoods of the multiple different types of problems being present at an asset to collectively increase in a manner that satisfies certain threshold criteria (e.g., an “aggregated” threshold that is to be compared to an average, summation, or other aggregation of the respective increases in likelihood, an “individual” threshold that is compared to each respective increase in likelihood, etc.). Such a precursor event may take other forms as well.

The types of precursor events that may be detected by the set of one or more precursor detection models executed by the first data analytics system may take various other forms as well.

Further, the one or more precursor detection models that are configured to detect the one or more respective types of precursor events may take various forms. According to one implementation, a precursor detection model may be configured to (1) receive, as input data, operating data for an asset, (2) perform certain data analytics on the input values to determine whether there has been an occurrence of the model's respective type of precursor event (i.e., whether there has been a particular type of change in the asset's operating condition that is indicative of a potential problem at the asset), and (3) output data associated with each detected occurrence of the model's respective type of precursor event.

In this implementation, the operating data for the asset that is input into the precursor detection model may take various forms. As one example, the operating data may take the form of a sequence of time-series values that are captured and/or generated by an asset for a given set of operating data variables (e.g., values output by a given set of sensors at the asset). Other examples are possible as well. In addition to the operating data for the asset, it is also possible that the precursor detection model may take other data as input as well. For instance, in some implementations, the first data analytics platform may be supplied with contextual data that is not normally available to the first data analytics platform (e.g., by virtue of the second data analytics platform sending the first data analytics platform such data), in which case this contextual data could also serve as input data for the precursor detection model.

The data associated with each occurrence of the given type of precursor event that is output by the precursor detection model may likewise take various forms. As one possibility, the data associated with each occurrence of the given type of precursor event may comprise an indicator that the precursor detection model outputs each time an occurrence of the given type of precursor event is detected, which may be referred to as a “precursor event indicator.” Such a precursor event indicator may take various forms. As one example, the precursor event indicator may comprise a descriptor of the respective type of precursor event detected by the model (e.g., a code or other alphanumerical descriptor). As another example, the precursor event indicator may simply take the form of a binary bit, a flag, or the like, in which case the asset may associate the indicator with a descriptor of the respective type of precursor event detected by the model when reporting a precursor event occurrence to other systems (e.g., the asset data platform 102). In either example, a precursor event indicator may also include or be associated with an indication of a time at which a precursor event occurrence has been detected, a location at which a precursor event occurrence has been detected, and/or a confidence value associated with a detection of a precursor event occurrence. A precursor event indicator output by a precursor detection model may take other forms as well.

As another possibility, in addition (or in alternative) to outputting a precursor event indicator each time a precursor event occurrence is detected, the precursor detection model may output (or the given asset may otherwise generate) a representation of operating data that is related to a precursor event occurrence. For example, the precursor detection model may output a snapshot of the raw operating data that led to the precursor detection model detecting a precursor event occurrence at the asset 106 (e.g., operating data input into the model at or around the time that the precursor event occurrence was detected). As another example, the precursor detection model may output data derived from the raw operating data that led to the precursor detection model detecting a precursor event occurrence at the asset 106, such as a “roll-up” of the raw operating data (e.g., an average, mean, median, etc. of the values for an operating data variable over a given time window) or one or more features determined based on the raw operating data. The precursor detection model may output (or the given asset may otherwise generate) other representations of operating data related to a precursor event occurrence as well.

Each precursor detection model in the set of one or more precursor detection models may be defined in various manners. As one example, in the context of the network configuration 100, the local analytics device of the asset 106 may locally define one or more of the precursor detection models using supervised and/or unsupervised learning techniques, examples of which may include a regression, random forest, support vector machines (SVM), principal component analysis (PCA), clustering, and/or association technique. As another example, in the context of the network configuration 100, the asset data platform 102 may define one or more of the precursor detection models using supervised and/or unsupervised learning techniques, such as those previously mentioned. In this example, historical operating data for the asset 106 (e.g., signal data output by set of sensors, abnormal-condition indicators related to a particular sensor, etc.) may be collected and provided to the asset data platform 102 for use in defining the one or more precursor detection models, and then once the one or more precursor detection models are defined, the asset data platform 102 may deploy the one or more precursor detection models back to the local analytics device of the asset 106 (e.g., by transmitting model definition data to the asset 106). The set of one or more precursor detection models may be defined by other entities and/or in other manners as well.

Further, each precursor detection model in the set of one or more precursor detection models may be implemented at the first data analytics platform in various manners. As one possible example, a precursor detection model may be represented in an analytics-specific programming language, such as Portable Format for Analytics (PFA). As another example, a precursor detection model may be represented in a general-purpose programming language, such as C++, Java, Python, etc. Other examples are possible as well.

B. Provisioning a Second Data Analytics Platform with a Set of One or More Precursor Analysis Models

In accordance with the present disclosure, a second data analytics platform may then be provisioned with a second set of one or more predictive models related to the operation of the given asset, referred to herein as “precursor analysis models.” For instance, the second data analytics platform may be the asset data platform 102. However, as noted above, the second data analytics platform could be something other than the asset data platform 102, including but not limited to a data analytics platform at a job site or the like.

Each respective precursor analysis model may be a predictive model that is used by the second data analytics platform to perform a deeper analysis of occurrences of a respective type of precursor event detected at an asset and thereby predict whether a respective type of problem is present at the asset. For example, a given precursor analysis model may be used to analyze a precursor event occurrence of a respective type detected at an asset and thereby predict whether a failure is likely to occur at the asset in the near future (e.g., a failure of a given component or subsystem of given asset). As another example, a given precursor analysis model may be used to analyze a precursor event occurrence at an asset and thereby predict whether there is a signal anomaly at the asset. A precursor analysis model may be configured to predict whether other types of problems are present at an asset as well.

The one or more precursor analysis models may take various forms. According to one implementation, a precursor analysis model may be configured to (1) receive, as input data, data associated with a precursor event occurrence of a respective type as well as other “contextual” data available to the asset data platform 102 that may be used to analyze the precursor event occurrence (2) perform certain data analytics on the input values to predict whether a respective type of problem is present at the asset, and (3) output data indicating the model's prediction as to whether the respective type of problem is present at the asset.

In this implementation, the contextual data that is input into the precursor analysis model may take various forms. As one example, the contextual data may include one or more classes of data relevant to the respective type of problem that may generally not be available to an asset, such as repair history data, weather data, and/or operating data for other assets. As another example, the contextual data may include one or more classes of data that are generally available to an asset but are nevertheless not analyzed by the asset when monitoring for precursor event occurrences of the respective type. The contextual data may take other forms as well.

It should be understood a precursor analysis model could be configured to receive other types of input data as well. For example, the input data for a given precursor analysis model may include other operating data for the asset 106 that is not included in the data associated with a precursor event occurrence (e.g., operating data that was separately received from the asset 106 as part of another process), which may be used either in addition or in alternative to the data associated with the precursor event occurrence. As another example, the input data for a given precursor analysis model may include data associated with precursor events other than the one triggered execution of the precursor analysis model, such as data associated with other recent precursor events of the same type and/or data associated with precursor events of other types. A precursor analysis model's input data could take other forms as well.

The precursor analysis model's output may also take various forms. As one example, the precursor analysis model may simply output a binary bit, a flag, or the like that indicates whether or not the model is predicting that the respective type of problem is present at an asset. As another example, the precursor analysis model may output a descriptor of the respective type of problem (e.g., a code or other alphanumerical descriptor) when it appears likely that such a problem is present at the asset and may otherwise not output any data (i.e., it may output a null). As yet another example, the precursor analysis model may output data indicating a likelihood that the respective type of problem is present at asset (e.g., a probability value ranging from 0 to 100). The precursor analysis model's output may take other forms as well.

Each precursor analysis model in the set of one or more precursor analysis models may be defined in various manners. For example, in the context of the network configuration 100, the asset data platform 102 may define each precursor analysis model using supervised and/or unsupervised learning techniques, examples of which may include a regression, random forest, support vector machines (SVM), principal component analysis (PCA), clustering, and/or association technique. In this respect, the data used to define a precursor analysis model may include historical operating data generated by the asset 106 as well as other data that is relevant to the respective type of problem being predicted by the precursor analysis model (e.g., repair history data, weather data, operating data for other similar assets, etc.). This process may take various forms.

As one possible implementation, the asset data platform 102 may begin the process of defining a precursor analysis model for predicting whether a given type of problem is present at an asset by analyzing historical operating data for the group of related assets to identify past occurrences of the given type of problem at the assets in the group of related assets. The asset data platform 102 may identify these past occurrences of the given type of problem in various manners.

In some cases, the historical operating data may include “labels” that indicate when instances of the given type of problem occurred at the assets in the group of related assets, in which case the asset data platform 102 may identify the past occurrences of the given type of problem based on these labels. In other cases, the historical operating data may not include “labels” for the given type of problem, in which case the asset data platform 102 may identify the past occurrences of the given type of problem based on other data. For example, the asset data platform 102 may determine that the triggering of a given combination of abnormal-condition indicators within a given period of time is indicative of an occurrence of the given type of problem, in which case the asset data platform 102 may identify the past occurrences of the given type of problem by detecting instances of the assets in the group of related assets triggering the given combination of abnormal-condition indicators within the given period of time.

For each identified occurrence of the given type of problem at an asset in the group, the asset data platform 102 may then identify a respective set of historical operating data that is associated with the past occurrence of the given type of problem at the asset. This respective set of historical operating data may take various forms. As one example, the respective set of historical operating data identified by the asset data platform 102 may include signal data for a given set of sensors and/or actuators from the time before, during, and/or after the occurrence of the given type of problem at the asset. As another example, the respective set of historical operating data identified by the asset data platform 102 may include abnormal-condition indicators from the time before, during, and/or after the occurrence of the given type of problem at the asset. Other examples are possible as well.

Further, for each identified occurrence of the given type of problem at an asset in the group, the asset data platform 102 may also other historical data that is potentially relevant to the past occurrence of the given type of problem, such as repair history data for the asset at which the given type of problem occurred, historical weather data from the time and location where the given type of problem occurred, and/or historical operating data generated by other assets in the group at or around the time that the given type of problem occurred at the asset.

After identifying this data for each past occurrence of the given type of problem, the asset data platform 102 may then apply a supervised learning technique (e.g., a regression, random forest, SVM technique) to the identified data and thereby define a precursor analysis model of the type described above.

The function of defining a precursor analysis model may take various other forms as well. For instance, in addition (or in alternative) to the data described above, the precursor analysis model may be defined to receive other data related to asset operation as inputs. As a specific example, the precursor analysis model may receive data inputs known as “features,” which are derived from data generated at the asset-related data sources (e.g., the signal data for the asset 106). Features may take various forms, examples of which may include an average or range of sensor values that were historically measured when a failure occurred, an average or range of sensor-value gradients (e.g., a rate of change in sensor measurements) that were historically measured prior to an occurrence of a failure, a duration of time between failures (e.g., an amount of time or number of data-points between a first occurrence of a failure and a second occurrence of a failure), and/or one or more failure patterns indicating sensor measurement trends around the occurrence of a failure. One of ordinary skill in the art will appreciate that these are but a few example features that can be derived from sensor signals and that numerous other features are possible.

It should also be understood that, in some implementations, a precursor detection model and a corresponding precursor analysis model may be defined together during the same process. For example, the asset data platform 102 may initially define an overarching predictive model that accepts as inputs both operating data available at a given asset and other contextual data that is not available at the given asset, and the asset data platform 102 may then decompose this overarching predictive model into one or more precursor detection models that are each configured to perform a preliminary analysis of a given asset's operation based on the operating data available at the given asset and one or more precursor analysis models that are each configured to perform a deeper analysis of the given asset's operation based on the information communication from the one or more precursor detection models and additional contextual data available at the asset data platform 102.

Further, each precursor analysis model in the set of one or more precursor analysis models may be implemented at the second data analytics platform in various manners. As one possible example, a precursor analysis model may be represented in an analytics-specific programming language, such as PFA. As another example, a precursor analysis model may be represented in a general-purpose programming language, such as C++, Java, Python, etc. Other examples are possible as well.

C. Distributing Execution of a Predictive Model Between Data Analytics Platforms

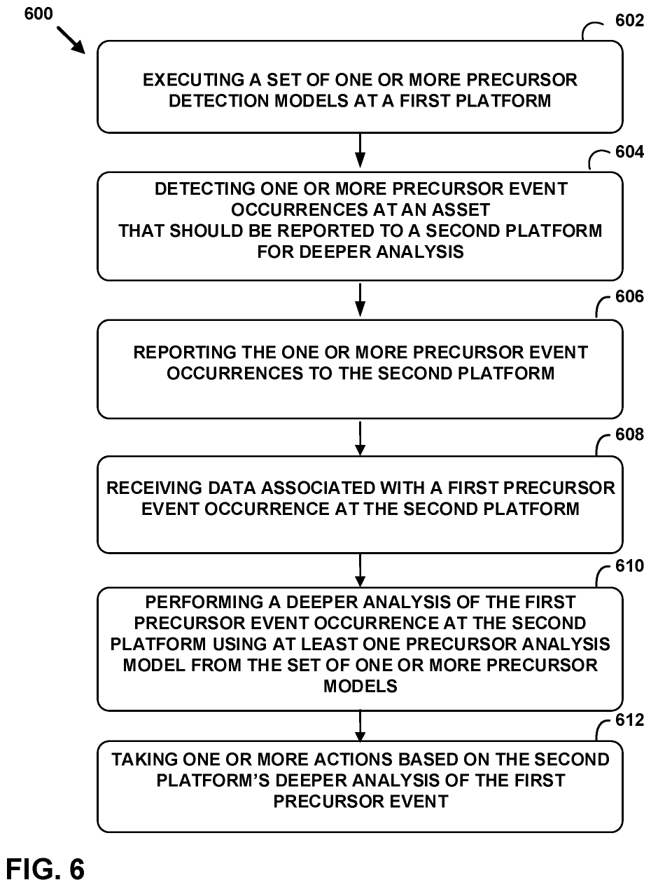

An example method for distributing execution of a predictive model between a first data analytics platform provisioned with a precursor detection model and a second data analytics platform provisioned with a precursor analysis model will now be described with reference to FIG. 6, which is a flow diagram 600 illustrating example functions associated with such a method. For purposes of illustration, the example functions are described as being carried out by the local analytics device of asset 106 and the asset data platform 102, but it should be understood that various other devices, systems, and/or platforms may perform the example functions. One of ordinary skill in the art will also appreciate that the flow diagram 600 is provided for sake of clarity and explanation and that other combinations of functions may be utilized to distribute execution of a predictive model between data analytics platforms. The example functions shown in the flow diagram may also be rearranged into different orders, combined into fewer blocks, separated into additional blocks, and/or removed based upon the particular embodiment, and other example functions may be added.

Beginning at block 602, the local analytics device of the asset 106 may be locally executing a set of one or more precursor detection models, each of which is configured to detect occurrences of a respective type of precursor event (i.e., a respective type of a change in the operating condition of the asset 106 that is indicative of a potential problem that merits deeper analysis). For instance, the local analytics device of the asset 106 may be locally executing a first precursor detection model for detecting occurrences of a first type of precursor event, a second precursor detection model for detecting occurrences of a second type of precursor event, etc. The function of locally executing the set of one or more precursor detection models may take various forms.

In one implementation, the local analytics device of the asset 106 may receive operating data captured and/or otherwise generated by the asset 106 that reflects the current operating conditions of the asset 106, such as signal data, abnormal-condition indicators, and/or features data. As it is receiving this operating data, the asset's local analytics device may then execute each precursor detection model by (1) identifying, from the received operating data, the respective set of operating data that is to be input into the precursor detection model (e.g., values for a respective set of operating data variables), (2) inputting the identified set of operating data into the precursor detection model while it is running to monitor for and detect any occurrences of the model's respective type of precursor event. Locally executing the set of one or more precursor detection models may involve other functions as well.

At block 604, while locally executing the set of one or more precursor detection models, the local analytics device of the asset 106 may detect one or more precursor event occurrences at the asset 106 that should be reported to the asset data platform 102 for deeper analysis. The local analytics device may perform this function in various manners. In one implementation, each precursor detection model may be configured to output a precursor detection indicator each time an occurrence of the model's respective type of precursor event is detected, in which case the local analytics device of the asset 106 may detect precursor event occurrences based on the output of each precursor detection model. In another implementation, the local analytics device of the asset 106 may perform a further analysis of a precursor detection model's output in order to determine whether there has been a precursor event occurrence, such as by evaluating whether the model's output satisfies one or more criteria. In yet another implementation, the local analytics device of the asset 106 may perform specific analyses that are directly coupled with the deeper analysis performed in the second analytics platform, enabling that deeper analysis to be distributed across both analytics platforms. The function of detecting precursor event occurrences at the asset 106 based on the set of one or more precursor detection models may take other forms as well.

At block 606, after the asset's local analytics device detects one or more precursor event occurrences at the asset 106, the asset 106 may report the one or more precursor event occurrences to the asset data platform 102, which may in turn trigger the asset data platform 102 to perform a deeper analysis of the one or more precursor event occurrences and thereby determine whether there is any problem present at the asset 106. This reporting function may take various forms.

In one example, each time a new occurrence of a given type of precursor event is detected, the asset 106 may be configured to responsively send data and/or analysis associated with the new occurrence of the given type of precursor event to the asset data platform 102 (and conversely, may be configured to not send this data in the absence of this detected precursor event). In another example, the asset 106 may be configured to compile data associated with precursor event occurrences that have been detected and then periodically send this to the asset data platform 102 (e.g., after a threshold number of precursor event occurrences have been detected). In yet another example, the first data analytics program may alter its activity to enable specialized analytics processing that is known beforehand to be analytically useful in the presence of a detected precursor condition. In still another example, the absence of a detected precursor condition may trigger a periodic status update event to be sent. The function of reporting precursor event occurrences (or the absence of same) to the asset data platform 102 may take other forms as well.

Further, in line with the discussion above, the data associated with a precursor event occurrence that is sent to the asset data platform 102 during the reporting function may take various forms. As one example, the data associated with a precursor event occurrence may include a precursor event indicator, which may comprise an indicator of the type of the precursor event and perhaps also a time, location, etc. of the precursor event occurrence. As another example, the data associated with a precursor event occurrence may include a representation of operating data that is related to the precursor event occurrence, such as the raw operating data that led to the detection of the precursor event occurrence and/or data derived therefrom (e.g., roll up data or some other computational output of the local analytics device). In yet another example, the absence of a detected precursor event occurrence may be reported, along with a summary of the analytics performed since the last reporting period. The data associated with a precursor event occurrence that is sent to the asset data platform 102 may take other forms as well.

In addition (or in alternative) to reporting the detected one or more precursor event occurrences to the asset data platform 102, the asset 106 (e.g., via the asset's location analytics device) may also be configured to perform certain additional analysis that may not otherwise be performed unless a given precursor condition has been detected. For example, after a given precursor condition is detected, the asset 106 (e.g., via the asset's location analytics device) may be configured to perform additional analysis in order to validate the given precursor condition before it is reported to the asset data platform 102, and/or the asset 106 (e.g., via the asset's location analytics device) may be configured to perform additional analysis in parallel with the deeper analysis of the asset data platform 102. Other implementations are possible as well.

At block 608, as a result of the foregoing, the asset data platform 102 may receive data associated with one or more precursor event occurrences, which may include at least a first precursor event occurrence of a first type.

At block 610, in response to receiving data associated with the first precursor event occurrence of the first type, the asset data platform 102 may perform a deeper analysis of the first precursor event occurrence using at least one precursor analysis model from the set of one or more precursor models. The asset data platform 102 may perform this function in various manners.

In one implementation, in response to receiving the data set from the asset 106, the asset data platform 102 may begin by identifying one or more precursor analysis models that are configured to perform a deeper analysis of precursor event occurrences of the first type, which may include at least a first precursor analysis model that is configured to perform a deeper analysis of precursor event occurrences of the first type and thereby predict whether a first type of problem is present at an asset. In practice, the asset data platform 102 may make this identification performing a lookup of the first type of precursor event in stored data that provides an associative mapping between the types of precursor events and the set of one or more precursor analysis models. (In this respect, it should be understood that each precursor event type could map to just a single precursor analysis model, or could map to multiple different precursor analysis models). However, the asset data platform 102 may make this identification in other manners as well.

After identifying the at least first precursor analysis model, the asset data platform 102 may then execute the first precursor analysis model in order to perform a deeper analysis of the first precursor event occurrence and thereby predict whether the first type of problem is present at the given asset. The function of executing the first precursor analysis model may take various forms.

As one possibility, the asset data platform 102 may begin by identifying the data that is to be input into the first precursor analysis model. In line with the discussion above, this data may include at least a portion of the data associated with the first precursor event occurrence that was received from the asset 106, as well as other contextual data available to the asset data platform 102 that may be used to analyze the precursor event occurrence (e.g., repair history data, weather data, and/or operating data for analytically-relevant assets other than the asset 106). Further, in line with the discussion above, the data to be input into the first precursor analysis model could take other forms as well. For example, the input data for a given precursor analysis model may include other operating data for the asset 106 that was not included in the data associated with the first precursor event occurrence that was received from the asset 106 (e.g., operating data that was separately received from the asset 106 as part of another process), which the asset data platform 102 may use either in addition or in alternative to the data associated with the first precursor event occurrence. As another example, the input data for a given precursor analysis model may include data associated with precursor events other than the first precursor event occurrence, such as data associated with other recent precursor events of the first type and/or data associated with precursor events of other types. The data to be input into the first precursor analysis model could take other forms as well.

After identifying the data that is to be input into the first precursor analysis model, the asset data platform 102 may then input the identified data into the first precursor analysis model and run the first precursor analysis model on the identified data, which results in a prediction of whether the first type of problem is present at the asset 106. Executing the first precursor analysis model may involve other functions as well.

As one real-world example of the disclosed process for distributed execution of a predictive model between data analytics platforms, the local analytics device at a locomotive may be provisioned with a precursor detection model that detects occurrences of a “wheel spinning” precursor event, which is a change in the amount of wheel spin at the locomotive that is indicative of a potential problem at the locomotive and thus merits deeper analysis. In turn, the asset data platform 102 may be provisioned with a precursor analysis model that performs a deeper analysis of occurrences of a “wheel spinning” precursor event using other contextual data that is not available to the locomotive (e.g., weather data and/or historical traction data) to predict whether there is indeed a problem at the locomotive. According to this real-world example, the local analytics device of the locomotive may send an indication of the “wheel spinning” precursor event occurrence to the asset data platform 102, which may trigger the asset data platform 102 to execute the precursor analysis model. Based on the precursor analysis model, the asset data platform 102 may predict whether the detected occurrence of the “wheel spinning” precursor event is indicative of a problem at the locomotive that needs to be addressed (e.g., a worn out wheel), or instead, whether the “wheel spinning” precursor event was detected for some other reason that is not related to a problem at the e.g., worn out wheel tread) (e.g., icy track conditions).

As another real-world example of the disclosed process for distributed execution of a predictive model between data analytics platforms, a local analytics device at a wind turbine may be provisioned with a precursor detection model that detects occurrences of a “vibration” precursor event, which is a change in the vibration of the wind turbine that is indicative of a potential problem at the wind turbine and thus merits deeper analysis. In turn, the asset data platform 102 may be provisioned with a precursor analysis model that performs a deeper analysis of occurrences of a “vibration” precursor event detected by the wind turbine using other contextual data that is not available to the wind turbine (e.g., weather data and/or operating data for other surrounding wind turbines) to predict whether there is indeed a problem at the wind turbine. According to this real-world example, the wind turbine may send an indication of the “vibration” precursor event occurrence to the asset data platform 102, which may trigger the asset data platform 102 to execute the precursor analysis model. Based on the precursor analysis model, the asset data platform 102 may predict whether the detected occurrence of the “vibration” precursor event is indicative of a problem at the wind turbine that needs to be addressed (e.g., a malfunctioning anemometer), or instead, whether the “vibration” precursor event was detected for some other reason that is not related to a problem at the wind turbine (e.g., highly variable wind conditions).

In the foregoing example, instead of equipping the wind turbine with a local analytics device, a control central at the wind site where the wind turbine is located may be configured to receive and aggregate operating data generated by wind turbines at the wind site and then execute the precursor detection model on such operating data. Alternatively, the wind turbine may be equipped with local analytics device that executes the precursor detection model as described above, but it may be the wind site's control center (rather than the asset data platform 102) that executes the precursor analysis model.

It should be understood that these real-world examples are merely provided for purposes of illustration, and that numerous other real-world examples exist as well.

At block 612, after performing the deeper analysis of the first precursor event occurrence, the asset data platform 102 may take one or more actions based on its analysis. The one or more actions may take a variety of forms.

As one possibility, the asset data platform 102 may send an indication of the results of the asset data platform's deeper analysis back to the asset 106. For example, the asset data platform 102 may send an indication of whether the first precursor event occurrence resulted in a prediction that there is a problem present at the asset. In practice, the asset data platform 102 may be configured to send such an indication to the asset 106 at least in circumstances when the identified one or more precursor analysis models predict that a problem is present at the asset 106, where some local action is deemed warranted by the asset's local analytics device, and perhaps also in circumstances when the identified one or more precursor analysis model predict that there is not a problem present at the given asset.

As another possibility, based on the deeper analysis, the asset data platform 102 may transmit to the asset 106 one or more commands that facilitate modifying one or more operating conditions of the asset 106 and/or its local analytics device. For instance, if the asset data platform's identified one or more precursor analysis models predict that there is a problem at the asset 106, the asset data platform 102 may instruct the asset 106 to change its operation so as to reduce chances for damage to the asset until the problem is addressed. The one or more commands sent to the asset 106 may take various forms, examples of which may include a command to cause the asset to decrease (or increase) operational parameters such as velocity, acceleration, fan speed, propeller angle, and/or air intake, among many other examples.

As yet another possibility, the asset data platform 102 may send an indication of the results of the asset data platform's deeper analysis to a client station that is in communication with the asset data platform 102, such as client station 112 (e.g., data indicating the asset data platform's prediction as to whether any problem is present at the asset 106). The indication may in turn cause the client station to present visual and/or audible notification to a user via a user interface of the client station. The notification may take various forms, examples of which may include an email, a pop-up message, or an alarm, among others. In practice, the asset data platform 102 may be configured to send such an indication to a client station at least in circumstances when the identified one or more precursor analysis model predict that a problem is present at the asset 106, and perhaps also in circumstances when the identified one or more precursor analysis models predict that there is not a problem present at the given asset.

As still another possibility, based on the results of its deeper analysis, the asset data platform 102 may create a work order to repair the asset 106 (e.g., if the asset data platform's identified one or more precursor analysis models predict that there is a problem at the asset 106). The asset data platform 102 may transmit work-order data to a work-order system that causes the work-order system to output a work order. The work order may specify a certain repair to the asset to alleviate the problem predicted to occur. Additionally, or alternatively, the asset data platform 102 may cause an indication of the work order to be presented on the client station and may also allow a user of the client station to authorize a work order prior to it being executed.

As a further possibility, based on the results of its deeper analysis, the asset data platform 102 may generate and send part-order data to a parts-ordering system (e.g., if the asset data platform's identified one or more precursor analysis models predict that there is a problem at the asset 106). For example, the part-order data may identify a given part for the asset 106 that may be used to address the problem that is predicted to occur at the asset 106.

As yet a further possibility, if the asset data platform's deeper analysis of the first precursor event occurrence results in a prediction that there is not a problem present at the asset 106, the asset data platform 102 may store the data associated with the first precursor event occurrence of the first type into a database that is later used to evaluate and potentially update the precursor detection and/or analysis models being used. The asset data platform 102 may perform a similar function for various other assets. After compiling data associated with precursor event occurrences of the first type that did not result in a prediction that there is a problem, the asset data platform 102 later evaluate the data stored in this database to gain further insight regarding the precursor detection and/or analysis models. As one example, based on this evaluation, the asset data platform 102 may determine that the first type of precursor event is not a sufficiently accurate indicator of a problem at an asset, in which case the asset data platform 102 may cause the corresponding precursor detection model to be disabled. As another example, based on this evaluation, the asset data platform 102 may determine that that the first type of precursor event is indicative of a new type of problem for which a new precursor analysis model needs to be defined, in which case the asset data platform 102 may cause a new precursor analysis model to be built (e.g., by identifying patterns that may be indicative of a same type of previously undefined problem and then using the data that matches that pattern to build a new precursor analysis model). The remote computing system's evaluation of precursor event occurrences of the first type that did not lead to a prediction of any problem being present at an asset may take other forms as well.

As still a further possibility, based on the results of its deeper analysis, the asset data platform 102 may trigger additional analysis to be performed by the local analytics device at the asset 106, the asset data platform 102, and/or some other analytics platform. In this respect, the location where the additional analysis is performed may be dictated by various considerations, examples of which may include (1) the location(s) where the data to be used for the additional analysis is accessible (e.g., a local analytics system may potentially have full access to asset-generated data but limited or no access to non-asset generated contextual data sources, whereas a remote analytics system may have full access to non-asset generated contextual data sources but only limited or no access to certain types of asset-generated data) and (2) the available compute resources at the different locations (e.g., a local analytics system may be constrained in multiple ways, including lack of physical compute capacity, restricted access to asset-generated data due to potential risk of disrupting asset behavior when accessing data from it, etc., whereas a remote analytics system may generally have more widely-available compute resources).

Further, the additional analysis triggered based on the first precursor analysis model's output may take various forms. As one possibility, if the asset data platform's deeper analysis of the first precursor event is inconclusive, the asset data platform 102 may also cause the asset's local analytics device to execute one or more additional models to help gain further insight regarding the first precursor occurrence. In practice, the one or more additional models may be models that are not executed during the normal operation of the asset 106, but rather are only executed on an “as needed” basis. There may be various reasons for this, including that the one or more additional models may require increased computing resources that may take away resources for other functions performed on the asset 106.

These one or more additional models may take a variety of forms. As one possibility, the one or more additional models may include a transient model (which may also be referred to as a temporal model), which may analyze how certain operating data for the asset 106 changes over a defined time. For instance, a transient model may compare how signal data from a particular set of sensors changed from a first time instance to a second time instance. The change may include a magnitude of change and/or direction of change, e.g., increase or decrease of the signal data. In turn, the output of the transient model may be communicated back to the asset data platform 102, which may use that output to assist in its efforts to predict whether a problem is present at the asset 106. The one or more additional models may take other forms as well.

The asset data platform 102 may perform various other actions based on its deeper analysis of the predicted occurrence of the anomaly as well.

The example method disclosed herein may thus enable the execution of predictive models related to an asset's operation to be distributed between multiple data analytics platforms, where a first data analytics platform functions to perform a preliminary analysis of the asset's operation based on the operating data available for the asset 106 and then trigger at least a second data analytics platform 102 to perform a deeper analysis of the asset's operation in circumstances where the first data analytics platform's preliminary analysis indicates that a potential problem may be present at the asset. Such a method provides several advantages.

As one example, the disclosed approach may lead to a reduction in the amount of operating data that is sent from the source of the data on which the predictive model is based to a remote data analytics platform (e.g., by only sending data associated with precursor event occurrences), which may in turn reduce transmission costs and/or data retention costs. As another example, the disclosed approach may enable a remote data analytics platform to execute predictive models related to an asset's operation on an “as needed” (or “on demand”) basis rather than on a continuous (or regular) basis, which may in turn reduce the computing resources that are required in order to evaluate the asset's operation. As yet another example, the remote data analytics platform may process its analysis differently and with better analytics performance due to the performance of precursor analytics near the source of the data. The approach disclosed herein may lead to several other advantages as well.

There are also several possible variations and extensions of the approach disclosed herein. For instance, in one embodiment, the set of one or more precursor detection models and the set of one or more precursor analysis models could be implemented by the same data analytics platform, rather than two different data analytics platforms. In other words, in such an embodiment, the first data analytics platform (e.g., a local analytics device at an asset) may be configured to execute the set of one or more precursor analysis models on an “as needed” basis as precursor event occurrences are detected by the first data analytics platform, which may avoid the need to transmit data indicating precursor event occurrences to a second data analytics platform during normal operation.

In another embodiment, execution of a precursor analysis model may be triggered by something more than the detection of a single precursor event occurrence. For example, the second data analytics platform could be configured to execute a given precursor analysis model in response to receiving data associated with a threshold number of precursor event occurrences of the same type at the asset 106, as opposed to just a single of precursor event occurrence of that type. As another example, the second data analytics platform could be configured to execute a given precursor analysis model in response to receiving data associated with occurrences of a certain combination of precursor event types at the asset 106. As another example, the second data analytics platform could be configured to execute a given precursor analysis model in response to both receiving data associated with a precursor event occurrence of a given type at the asset 106 and also determining that the asset 106 meets certain other criteria. In yet another example, the second data analytics platform may modify execution of a deeper analytics model by ignoring, emphasizing, or otherwise altering certain aspects of model execution as a direct consequence of the presence or absence of one or more precursor event occurrences. The second data analytics platform could be configured to execute a given precursor analysis model in response to other triggers as well.

In another yet embodiment, in addition (or in alternative) to being provisioned with the set of one or more precursor detection models, the first data analytics platform (e.g., a local analytics device at an asset) may be provisioned with a set of one or more predictive models that are each configured to predict whether a respective type of problem is present at the asset, such as a failure or a signal anomaly. In practice, each of these predictive models may be a “simplified” (or “approximated”) version of a corresponding predictive model available at the second data analytics platform (e.g., in terms of the complexity of the precursor model and/or the set of data that is input into the precursor model). In such an embodiment, a simplified model's prediction that a problem is present at the asset 106 may be reported by the first data analytics platform to the second data analytics platform, which may in turn trigger the second data analytics platform to identify and execute the corresponding model in order to perform a deeper analysis of the first data analytics platform's prediction and thereby verify whether that prediction is accurate. This deeper analysis by the second data analytics platform may result in one of at least three possible outcomes: (1) the second data analytics platform may agree with the first data analytics platform's prediction, (2) the second data analytics platform may disagree with the first data analytics platform's prediction, or (3) the second data analytics platform's deeper analysis of the prediction may be inconclusive.

After performing this deeper analysis of the first data analytics platform's prediction of a given type of problem at the asset, the second data analytics platform may then take actions similar to those described above. For example, the second data analytics platform may report the results of its deeper analysis back to the first data analytics platform, the asset 106 (to the extent the first data analytics platform is not the asset's local analytics device), and/or to a client station. As another example, based on its deeper analysis, the second data analytics platform may send instructions to the asset 106, a work-order system, a parts-ordering system, or the like. As still another example, if the second data analytics platform disagrees with the first data analytics platform's prediction, it may store the data associated with the prediction into a database that is later used to evaluate and potentially update the simplified and/or corresponding models. As a further example, if the second data analytics platform's deeper analysis of the prediction is inconclusive, the second data analytics platform may trigger additional analysis to be performed by the first data analytics platform, second data analytics platform, and/or some other platform. Other examples are possible as well.

In still another embodiment, a process similar to that described above may be carried out in an arrangement that includes three data analytics platforms. For example, local analytics device at the asset 106 may be configured to execute a precursor detection model and communicate the results to an intermediate data analytics platform, which may be configured to receive and aggregate data from a plurality of assets and then execute precursor analysis models based on such data. In turn, the intermediate data analytics platform may be configured to communicate the results of its precursor analysis models to the asset data platform 102, which may be configured to execute precursor analysis models based on the data received from the intermediate data analytics platform as well as other contextual data. In this respect, the intermediate data analytics platform's precursor analysis models may effectively serve as precursor detection models from the perspective of the asset data platform 102.

Other variations and extensions of the disclosed approach may exist as well.

### VI. CONCLUSION

Example embodiments of the disclosed innovations have been described above. Those skilled in the art will understand, however, that changes and modifications may be made to the embodiments described without departing from the true scope and sprit of the present invention, which will be defined by the claims.

Further, to the extent that examples described herein involve operations performed or initiated by actors, such as “humans”, “operators”, “users” or other entities, this is for purposes of example and explanation only. The claims should not be construed as requiring action by such actors unless explicitly recited in the claim language.

1. A given data analytics platform comprising:
a network interface configured to communicatively couple the given data analytics platform to at least a first other data analytics platform that is provisioned with a set of one or more precursor detection models related to asset operation;
at least one processor;
a non-transitory computer-readable medium; and
program instructions stored on the non-transitory computer-readable medium that are executable by the at least one processor to cause the given data analytics platform to:
receive, from the first other data analytics platform, data associated with a given occurrence of a given type of precursor event at a given asset that is detected by the first other data analytics platform using a given precursor detection model of the set of one or more precursor detection models;
in response to receiving the data associated with the given occurrence of the given type of precursor event, (a) identify, from a set of one or more precursor analysis models available to be executed at the given data analytics platform, at least one precursor analysis model that is associated with the given type of precursor event and predicts whether a given type of problem is present at an asset and (b) execute the at least one precursor analysis model to perform a deeper analysis of the given occurrence of the given type of precursor event and thereby output a prediction of whether the given type of problem is present at the given asset; and
take one or more actions based on the prediction of whether the given type of problem is present at the given asset.

2. The given data analytics platform of claim 1, wherein the given type of precursor event comprises a given type of change in the operating conditions of the given asset that is indicative of a potential problem at the given asset.

3. The given data analytics platform of claim 1, wherein the given precursor detection model comprises a predictive model that is configured to (a) receive, as input data, a given set of operating data for the given asset, (b) perform data analytics on the input data to determine whether there has been an occurrence of the given type of precursor event, and (c) output data associated with each detected occurrence of the given type of precursor event.

4. The given data analytics platform of claim 1, wherein the data associated with the given occurrence of the given type of precursor event comprises an indicator that the given occurrence of the given type of precursor event has been detected by the given asset and a representation of operating data associated with the given occurrence of the given type of precursor event.

5. The given data analytics platform of claim 1, wherein the at least one precursor analysis model comprises a predictive model that is configured to (a) receive, as input data, at least a portion of the data associated with the given occurrence of the given type of precursor event as well as other contextual data available to the given data analytics platform, (b) perform data analytics on the input data to predict whether the given type of problem is present at the given asset, and (c) output data indicating the prediction of whether the given type of problem is present at the given asset.

6. The given data analytics platform of claim 5, wherein the contextual data comprises data relevant to the given type of problem that is not available to the first other data analytics platform.

7. The given data analytics platform of claim 1, wherein the program instructions that are executable by the at least one processor to cause the given data analytics platform to take one or more actions based on the prediction of whether the given type of problem is present at the given asset comprise program instructions stored on the non-transitory computer-readable medium that are executable by the at least one processor to cause the given data analytics platform to:
if the output comprises a prediction that the given type of problem is present at the given asset, report the prediction to one or both of the first other data analytics platform and a client station; and
if the output comprises a prediction that the given type of problem is not present at the given asset, store the data associated with the given occurrence of the given type of precursor event in a given database that is subsequently used to update one or both of (a) the set of one or more precursor detection models at the first other data analytics platform and (b) the set of one or more precursor analysis models at the given data analytics platform.

8. The given data analytics platform of claim 7, further comprising program instructions stored on the non-transitory computer-readable medium that are executable by the at least one processor to cause the given data analytics platform to:
in the given database, identify data associated with occurrences of the given type of precursor event that did not result in a prediction of any problem being present at an asset;
based on an evaluation of the identified data, determine that the given type of precursor event is indicative of a new type of problem for there is no precursor analysis model included in the set of one or more precursor analysis models; and
use the identified data to build a new precursor analysis for the new type of problem.

9. The given data analytics platform of claim 7, further comprising program instructions stored on the non-transitory computer-readable medium that are executable by the at least one processor to cause the given data analytics platform to:
in the given database, identify data associated with occurrences of the given type of precursor event that did not result in a prediction of any problem being present at an asset;
based on an evaluation of the identified data, determine that the given precursor detection model is not a sufficiently accurate indicator of a problem at an asset; and
instruct the first other data analytics platform to disable the given precursor detection model.

10. The given data analytics platform of claim 1, wherein the program instructions that are executable by the at least one processor to cause the given data analytics platform to take one or more actions based on the prediction of whether the given type of problem is present at the given asset comprise program instructions stored on the non-transitory computer-readable medium that are executable by the at least one processor to cause the given data analytics platform to:
instruct the first other data analytics platform to perform additional analysis of the given occurrence of the given type of precursor event.

11. The given data analytics platform of claim 1, wherein the first other data analytics platform comprises a local analytics device of the given asset.

12. A method comprising:
receiving, at a given data analytics platform from at least a first other data analytics platform that is provisioned with a set of one or more precursor detection models related to asset operation, data associated with a given occurrence of a given type of precursor event at a given asset that is detected by the first other data analytics platform using a given precursor detection model of the set of one or more precursor detection models;
in response to receiving the data associated with the given occurrence of the given type of precursor event, (a) identifying, from a set of one or more precursor analysis models available to be executed at the given data analytics platform, at least one precursor analysis model that is associated with the given type of precursor event and predicts whether a given type of problem is present at an asset and (b) executing the at least one precursor analysis model to perform a deeper analysis of the given occurrence of the given type of precursor event and thereby output a prediction of whether the given type of problem is present at the given asset; and
taking one or more actions based on the prediction of whether the given type of problem is present at the given asset.

13. The method of claim 12, wherein the given type of precursor event comprises a given type of change in the operating conditions of the given asset that is indicative of a potential problem at the given asset, and wherein the given precursor detection model comprises a predictive model that is configured to (a) receive, as input data, a given set of operating data for the given asset, (b) perform data analytics on the input data to determine whether there has been an occurrence of the given type of precursor event, and (c) output data associated with each detected occurrence of the given type of precursor event.

14. The method of claim 12, wherein the at least one precursor analysis model comprises a predictive model that is configured to (a) receive, as input data, at least a portion of the data associated with the given occurrence of the given type of precursor event as well as other contextual data available to the given data analytics platform, (b) perform data analytics on the input data to predict whether the given type of problem is present at the given asset, and (c) output data indicating the prediction of whether the given type of problem is present at the given asset.

15. The method of claim 12, wherein taking one or more actions based on the prediction of whether the given type of problem is present at the given asset comprises:
if the output comprises a prediction that the given type of problem is present at the given asset, reporting the prediction to one or both of the first other data analytics platform and a client station; and
if the output comprises a prediction that the given type of problem is not present at the given asset, storing the data associated with the given occurrence of the given type of precursor event in a given database that is subsequently used to update one or both of (a) the set of one or more precursor detection models at the first other data analytics platform and (b) the set of one or more precursor analysis models at the given data analytics platform.

16. The method of claim 12, wherein taking one or more actions based on the prediction of whether the given type of problem is present at the given asset comprises:
instructing the first other data analytics platform to perform additional analysis of the given occurrence of the given type of precursor event.

17. The method of claim 12, wherein the first other data analytics platform comprises a local analytics device of the given asset.

18. A system comprising:
a first data analytics platform that is provisioned with a set of one or more precursor detection models related to asset operation; and
a second data analytics platform that is provisioned with a set of one or more precursor analysis models related to asset operation,
wherein the first data analytics platform comprises a non-transitory computer-readable medium having instructions stored thereon that are executable to cause the first data analytics platform to (a) execute the set of one or more precursor detection models, (b) based on a given precursor detection model of the set of one or more precursor detection models, detect a given occurrence of a given type of precursor event at a given asset, and (c) send data associated with the given occurrence of the given type of precursor event at the given asset to the second data analytics platform, and
wherein the second data analytics platform comprises a non-transitory computer-readable medium having instructions stored thereon that are executable to cause the second data analytics platform to (a) receive, from the first other data analytics platform, the data associated with the given occurrence of the given type of precursor event at the given asset, (b) in response to receiving the data associated with the given occurrence of the given type of precursor event, (i) identify, from the set of one or more precursor analysis models, at least one precursor analysis model that is associated with the given type of precursor event and predicts whether a given type of problem is present at an asset and (ii) execute the at least one precursor analysis model to perform a deeper analysis of the given occurrence of the given type of precursor event and thereby output a prediction of whether the given type of problem is present at the given asset, and (c) take one or more actions based on the prediction of whether the given type of problem is present at the given asset.

19. The system of claim 18, wherein the first data analytics platform comprises a local analytics device of the given asset, and wherein the second data analytics platform comprises an asset data platform that is located remotely from the given asset.

20. The system of claim 18, wherein the non-transitory computer-readable medium of the first data analytics platform further comprises instructions stored thereon that are executable to cause the first data analytics platform to perform additional analysis of the given occurrence of the given type of precursor event.
